(19) United States
(12) Patent Application Publication
(10) Pub. No.: US 2004/0175680 A1
(43) Pub. Date: Sep. 9, 2004

(54) Artificial intelligence platform

(76) Inventors: Michal Hlavac, Cambridge, MA (US); Senia Maymin, Belmont, MA (US); Cynthia Breazeal, Somerville, MA (US); Milos Hlavac, Bertrange (LU); Juraj Hlavac, Seattle, WA (US); Dennis Bromley, Watertown, MA (US)

Correspondence Address: Pandiscio & Pandiscio, P.C., 470 Totten Pond Road, Waltham, MA, 02451-1914, US

(21) Appl. No.: 10/659,007

(22) Filed: Sep. 9, 2003

Related U.S. Application Data
(60) Provisional application No. 60/409,328, filed on Sep. 9, 2002.

(51) Int. Cl. G09B 19/00

(52) U.S. Cl. 434/236

(57) ABSTRACT

The present invention provides a new and unique platform for authoring and deploying interactive characters which are powered by artificial intelligence. The platform permits the creation of a virtual world populated by multiple characters and objects, interacting with one another so as to create a life-like virtual world and interacting with a user so as to provide a more interesting and powerful experience for the user. This system can be used for entertainment purposes, for commercial purposes, for educational purposes, etc.

### REFERENCE TO PENDING PRIOR PATENT APPLICATION

This patent application claims benefit of pending prior U.S. Provisional Patent Application Serial No. 60/409,328, filed 09/09/02 by Michal Hlavac et al. for INGEENI ARTIFICIAL INTELLIGENCE PLATFORM (Attorney's Docket No. INGEENI-1 PROV), which patent application is hereby incorporated herein by reference.

### FIELD OF THE INVENTION

This invention relates to artificial intelligence in general, and more particularly to a novel software platform for authoring and deployment of interactive characters powered by artificial intelligence.

### BACKGROUND OF THE INVENTION

Artificial intelligence is the field of computer science concerned with creating a computer or other machine which can perform activities that are normally thought to require intelligence.

One subfield in this area relates to creating a computer which can mimic human behavior, i.e., so that the computer, or a character displayed by the computer, appears to display human traits.

A substantial amount of effort has been made in this latter area, i.e., to provide a computer character which appears to display human traits. Unfortunately, however, the efforts to date have generally proven unsatisfactory for a number of reasons. Among these are: (1) the artificial intelligence program must be generally custom made for each character, which is a costly and time-consuming process; (2) the artificial intelligence program must generally be custom tailored for a specific application program (e.g., for a specific game, for a specific educational program, for a specific search engine, etc.); (3) the characters tend to be standalone, and not part of a larger “virtual world” of interactive characters, etc.

### SUMMARY OF THE INVENTION

The present invention provides a new and unique platform for authoring and deploying interactive characters which are powered by artificial intelligence. The platform permits the creation of a virtual world populated by multiple characters and objects, interacting with one another so as to create a life-like virtual world and interacting with a user so as to provide a more interesting and powerful experience for the user. This system can be used for entertainment purposes, for educational purposes, for commercial purposes, etc.

In one form of the invention, there is provided a virtual world comprising:

a virtual environment;

a plurality of virtual elements within the virtual environment, each of the virtual elements being capable of interacting with other of the virtual elements within the virtual environment; and

user controls for enabling a user to interact with at least one of the virtual elements within the virtual environment;

wherein at least one of the virtual elements comprises a virtual character comprising a behavior state, an emotion state and a learning state, and wherein the behavior state, the emotion state and the learning state are capable of changing in response to (i) interaction with other virtual elements within the virtual environment, and/or (ii) commands from the user input controls; and

wherein the virtual environment is configured so that additional virtual elements can be introduced into the virtual environment.

In another form of the invention, there is provided a virtual character for disposition within a virtual environment, the virtual character comprising a behavior state, an emotion state and a learning state, and wherein the behavior state, the emotion state and the learning state are capable of changing in response to (i) interaction with other virtual elements within the virtual environment, and/or (ii) commands from outside the virtual environment.

And in one preferred embodiment, the virtual character further comprises a sensory capability for sensing other virtual elements within the virtual environment.

And in one preferred embodiment, the sensory capability is configured to sense the presence of other virtual elements within the virtual environment.

And in one preferred embodiment, the sensory capability is configured to sense the motion of other virtual elements within the virtual environment.

And in one preferred embodiment, the sensory capability is configured to sense a characteristic of other virtual elements within the virtual environment.

And in another form of the invention, there is provided a method for doing business comprising:

providing an individual with a virtual environment and at least one virtual element within the virtual environment, wherein the virtual environment is configured so that additional virtual elements can be introduced into the virtual environment, and wherein at least one of the virtual elements comprises a virtual character comprising a behavior state, an emotion state and a learning state, and wherein the behavior state, the emotion state and the learning state are capable of changing in response to stimuli received from within the virtual environment and/or from outside of the virtual environment; and

enabling a customer to add an additional virtual element to the virtual environment in response to the purchase of a product.

And in one preferred embodiment, the additional virtual element is different than the product being purchased.

And in one preferred embodiment, the product comprises a good.

And in one preferred embodiment, the product comprises a service.

And in one preferred embodiment, the product is purchased by the customer on-line.

And in one preferred embodiment, the product is purchased by the customer at a physical location.

And in one preferred embodiment, the additional virtual element is delivered to the customer on-line.

And in one preferred embodiment, the additional virtual element is delivered to the customer on electronic storage media.

And in one preferred embodiment, the additional virtual element is configured to change state in response to stimuli received from within the virtual environment and/or from outside the virtual environment.

And in one preferred embodiment, the additional virtual element comprises a virtual character.

And in one preferred embodiment, the method comprises the additional step of enabling a customer to add an additional virtual element to the virtual environment without the purchase of a product.

And in one preferred embodiment, the method comprises the additional step of tracking the results of customer interaction through metrics specific to a measure of Brand Involvement.

And in another form of the invention, there is provided a method for teaching a skill to an individual comprising:

providing a virtual world comprising:

a virtual environment;

a plurality of virtual elements within the virtual environment, each of the virtual elements being capable of interacting with other of the virtual elements within the virtual environment; and

user controls for enabling an individual to interact with at least one of the virtual elements within the virtual environment;

wherein at least one of the virtual elements comprises a virtual character comprising a behavior state, an emotion state and a learning state, and wherein the behavior state, the emotion state and the learning state are capable of changing in response to (i) interaction with other virtual elements within the virtual environment, and/or (ii) commands from the user controls;

presenting a learning circumstance to the individual through the use of the virtual elements within the virtual environment;

prompting the individual to provide instructions to at least one of the virtual elements within the virtual environment, wherein the instructions being provided by the individual incorporate the skill to be taught to the individual, such that the individual learns the skill by providing instructions to the at least one virtual element; and

providing positive reinforcement to the individual when the instructions provided by the individual are correct.

And in one preferred embodiment, the instructions are provided to a virtual character.

And in one preferred embodiment, the individual learns the skill by teaching that same skill to a virtual character.

And in one preferred embodiment, the instructions comprise direct instructions.

And in one preferred embodiment, the instructions comprise indirect instructions.

And in one preferred embodiment, the indirect instructions comprise providing an example.

And in one preferred embodiment, the indirect instructions comprise creating an inference.

And in one preferred embodiment, the virtual environment is configured so that additional virtual elements can be introduced into the virtual environment.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts and further wherein:

FIG. 1 is a schematic view providing a high level description of the novel artificial intelligence platform of the present invention;

FIG. 2 is a schematic view providing a high level description of the platform's Studio Tool;

FIG. 3 is a schematic view providing a high level description of the platform's AI Engine;

FIG. 4 is a schematic view providing a high level description of the functionality of the Music Engine;

FIG. 5 is a schematic view providing a high level description of the platform's behavior engine;

FIG. 6 is a schematic view providing a high level description of the behavior hierarchy of a character;

FIG. 7 is a schematic view showing how a three dimentional space can be partitioned into distinct regions that correspond to the individual emotions of a character;

FIG. 8 is a table which shows the trigger condition, resulting behavior and the behavioral function for six of the ten cardinal emotions;

FIG. 9 is a schematic diagram illustrating one form of layered animation model within the Animation Engine;

FIG. 10 is a schematic diagram illustrating some similarities between the layered animation model of the present invention and the Adobe Photoshop model;

FIG. 11 is a further schematic diagram illustrating layering within the layered animation model;

FIG. 12 is a schematic diagram illustrating blending within the layered animation model;

FIG. 13 is a schematic diagram illustrating interaction between the Animation Engine and the Behavior Engine;

FIG. 14 is a schematic view providing a high level description of the platform's AI Player;

FIG. 15 is a schematic view providing a more detailed view of the AI Player;

FIG. 16 is a schematic view providing a high level description of the platform's Persister;

FIG. 17 is a schematic view providing a high level description of the interaction between the platform's Authorizer and Code Enter components;

FIG. 18 is a schematic view providing a high level description of user input to the AI Player;

FIG. 19 is a schematic view providing a high level description of the code layers of the AI Player;

FIG. 20 is a schematic diagram showing a parallel between (i) the architecture of the WildTangent™ plugin, and (ii) the architecture of the AI Player together with WildTangent™ graphics;

FIG. 21 is a table showing how the platform is adapted to run on various operating systems and browers;

FIG. 22 is a schematic view providing a high level description of the Studio Tool;

FIG. 23 is a table showing how the list of importers can expand;

FIG. 24 is a schematic view providing a high level description of the platform's sensor system;

FIG. 25 is a schematic view providing a high level description of the platform's behavior system;

FIG. 26 is a schematic view providing a high level description of the platform's emotion system;

FIG. 27 is a schematic view showing the platform's AVS emotional cube;

FIG. 28 is a schematic view providing a high level description of the platform's learning system;

FIG. 29 is a schematic view providing a high level description of the platform's motor system;

FIG. 30 shows the sequence of updates used to propagate a user change in a character's behavior network all the way through to affect the character's behavior;

FIG. 31 is a schematic diagram providing a high level description of the system's AI architecture;

FIG. 32 is a schematic diagram providing a high level description of the system's three-tiered data architecture;

FIG. 33 is a schematic diagram illustrating how the system becomes more engaging for the user as more elements are introduced into the virtual world;

FIG. 34 is a schematic diagram illustrating possible positive and negative interactions as a measure of Brand Involvement;

FIG. 35 is a table showing various code modules/libraries and their functionality in one preferred implementation of the invention;

FIG. 36 is a schematic diagram showing one way in which the novel platform may be used;

FIG. 37 is a schematic diagram showing another way in which the novel platform may be used;

FIG. 38 is a schematic diagram showing still another way in which the novel platform may be used; and

FIG. 39 is a schematic diagram showing the general operation of the novel platform of the present invention.

### DETAILED DESCRIPTION OF THE PREFERRED EMBODIMENTS

1. Overall System

The present invention comprises a novel software platform for authoring and deployment of interactive characters powered by Artificial Intelligence (AI). The characters must convey a strong illusion of life. The AI that brings the characters to life is based on a unique mix of Behavior, Emotion and Learning.

The core AI functionality is the heart of a complex software system that is necessary to make the AI applicable in the real world. The full system consists of:

(i) the AI Engine, the “heart” of the system;

(ii) the AI Player, a software system that wraps the AI Engine for deployment;,

(iii) the Studio Tool, a standalone application that wraps the AI Engine for authoring;, and

(iv) the .ing File Format, a proprietary data and file format for AI specification. Together, these systems constitute the Artificial Intelligence Platform.

The AI-powered animated characters are deployable over the Web. It is also possible to deploy them on a CD-ROM.

The system is focused on AI and is not yet another graphics solution. However, the system benefits from existing “graphics-over-the-Web” solutions.

1.1 Runtime—The AI Engine

The AI Engine is the heart of the system. It is a software system that determines what a given character does at any given moment (behavior), how it “feels” (emotion) and how its past experience affects its future actions (learning).

The AI Engine relies on other systems to become useful as a release-ready application, whether as a plugin to a Web browser or as a standalone software tool. The AI Engine also relies on a proprietary data structure, the “AI Graph”, that resides in memory, and a proprietary file format, the ing file format, that stores the AI Graph data structure.

1.2 Data—The .ing File Format

The .ing file format is a proprietary data file format that specifies the AI behavioral characteristics of a set of characters inside a virtual world. The .ing file format does not contain any information about graphics or sound; it is a purely behavioral description. The .ing file format is registered within an operating system (e.g., Windows) to be read by the AI Player. The Studio Tool reads and writes the .ing file format.

1.3 Deployment—The AI Player

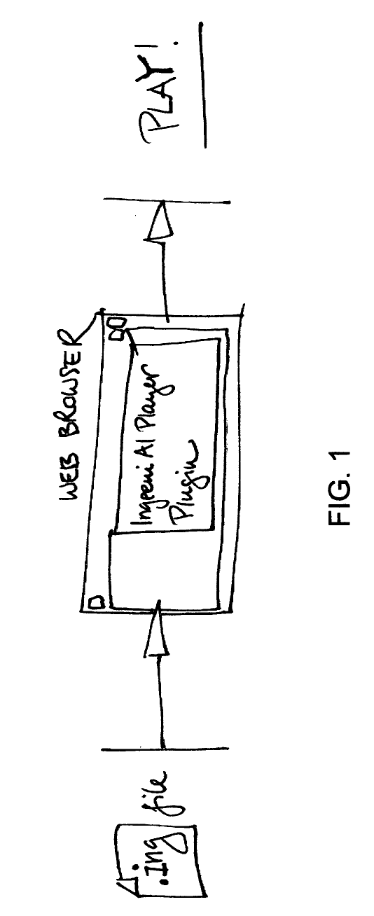

Looking first at FIG. 1, the AI Player is a plug-in to a Web browser. The AI Player contains the core AI Engine and plays out the character's behaviors as specified in the .ing file. The AI Player self-installs into the browser the first time the Web browser encounters an .ing file.

The AI Player is not a graphics solution. It runs on top of a 3rd party graphics plugin such as Flash™, WildTangent™, Pulse3d™, etc. As a result, the final interactive requires the .ing file together with one or more graphics, animation and music data files required by the chosen graphics plugin.

1.4 Authoring—The Studio Tool

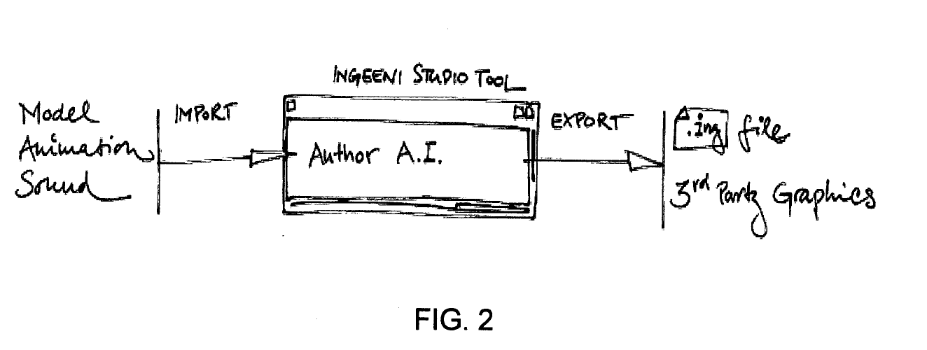

Looking next at FIG. 2, the Studio Tool is a standalone application. The Studio Tool consists of a graphical editing environment that reads in data, allows the user to modify that data, and writes the modified data out again. The Studio Tool reads in the .ing file together with industry-standard file formats for specifying 3D models, animations, textures, sounds, etc. (e.g., file formats such as .obj, .mb, .jpg, .wav, etc.). The Studio Tool allows the user to compose the characters and to author their behavioral specifications through a set of Graphical User Interface (GUI) Editors. A real-time preview is provided in a window that displays a 3D world in which the characters “run around”, behaving as specified. Changing any parameter of a character's behavior has an immediate effect on the character's actions as performed in the preview window. Finally, the Studio Tool allows the user to export all information inherent in the character's AI, scene functionality, camera dynamics, etc., as one or more ing files. All graphical representations of the character are exported in the form of existing 3rd party graphics formats (e.g., WildTangent™, Flash™, etc.). The user then simply posts all files on his or her Website and a brand-new intelligent animated character is born.

2. The AI Engine

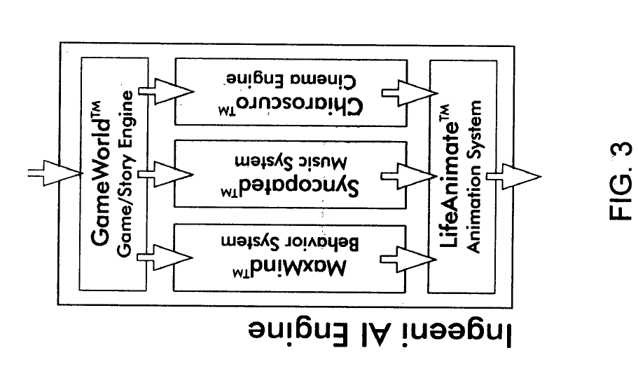

FIG. 3 is a schematic diagram providing a high level description of the functionality of the AI Engine.

2.1 Basic Functionality

The AI Engine is a software system that determines what a given creature does at any given moment (behavior), how it “feels” (emotion) and how its past experience affects its future actions (learning). The AI Engine is the heart of the system, giving the technology its unique functionality. The AI Engine traverses an AI Graph, a data structure that resides in memory and represents the behavioral specification for all creatures, the world and the camera. Each traversal determines the next action taken in the world based on the user's input. The AI Engine also modifies the AI Graph, for example, as a result of the learning that the creatures perform.

2.2 Story Engine

The story engine imposes a high-level story on the open-ended interactions. Instead of developing a complex story engine initially, the system can provide this functionality through the use of the Java API.

2.3 Music Engine

The AI Engine has a music engine together with a suitable file format for music data (e.g., MIDI is one preferred implementation). The Music Engine matches and plays the correct sound effects and background music based on the behavior of the characters and the overall mood of the story provided by the story engine.

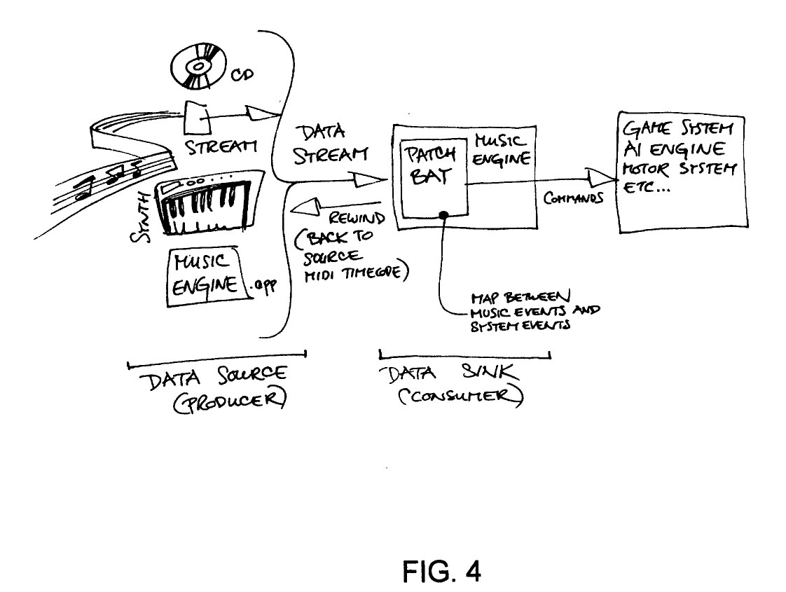

FIG. 4 is a schematic diagram providing a high level description of the functionality of the Music Engine.

In most other interactive systems, the music engine comes last, i.e., it is only added after all game, behavior, and animation updates are computed. The present invention pushes the music engine higher up the hierarchy—the music controls the animation, triggers the sunset, or motivates a character's actions or emotions. In this way, a vast amount of authoring tools and expertise (music production) can be used to dramatically produce compelling emotional interactions with the audience.

The music engine may be, without limitation, both a controlling force and a responsive force. The following points detail how data to and from the music engine can control various parts of the character system, or even the entire system.

Definition of terms:

Music Engine—the program functionality that interprets incoming data, possibly from a musical or audio source, and somehow affects or alters the system.

Animation Clip—an authored piece of artwork, 3D or 2D, that may change over time.

Model—2D art or 3D model that has been authored in advance, possibly matched to and affected by an animation clip.

Data Source—any source of data, possibly musical, such as (but not limited to) a CD or DVD, a stream off the Web, continuous data from a user control, data from a music sequencer or other piece of software, or data from a piece of hardware such as a music keyboard or mixing board.

Data Stream—The data that is being produced by a data source.

Skill—A piece of functionality associated with the character system.

Based on an incoming data stream, the music engine may take an animation clip and alter it in some way, i.e., without limitation, it may speed it up, slow it down, exaggerate certain aspects of the motion, or otherwise change the fundamental characteristics of that animation clip. By way of example but not limitation, if the stream source is a long, drawn-out stretching sound effect, the music engine may stretch the animation length out to match the length of the sound effect.

Based on an incoming data stream, the music engine may take a model and alter it in some way, e.g., it may stretch it, color it, warp it somehow, or otherwise change the fundamental characteristics of that model. By way of example but not limitation, if the incoming data stream is a stream of music and the music genre changes from Rock and Roll to Blues, the music engine may change the color of the model to blue.

Based on an incoming data stream, the music engine may start and stop individual (possibly modified) animations or sequences of animations. By way of example but not limitation, assume there is a model of a little boy and an animation of that model tip-toeing across a floor. The data stream is being created by a music sequencing program and the user of that program is writing “tiptoe” music, that is, short unevenly spaced notes. The music engine interprets the incoming stream of note data and plays out one cycle of the tiptoe animation for every note, thereby creating the effect of synchronized scoring. By way of further example, if the stream switched to a “CRASH!” sound effect, the music engine would trigger and play the trip-and-fall animation clip, followed by the get-up-off-the floor animation clip, followed, possibly, depending on the data stream, by more tiptoeing.

Based on an incoming data stream, the music engine may alter system parameters or system state such as (but not limited to) system variables, blackboard and field values, or any other piece of system-accessible data. By way of example but not limitation, a music data stream may contain within it a piece of data such that, when the musical score becomes huge and romantic and sappy, that control data, interpreted by the music engine, alters the state of a character's emotional and behavior system such that the creature falls in love at exactly the musically correct time.

Based on an incoming data stream, the music engine may start and stop skills. By way of example but not limitation, when the incoming data stream contains the humorous “buh dum bump!” snare hit following a comedy routine, the music engine might trigger the crowd-laugh skill.

Based on an incoming data stream, the music engine may “stitch together”, in sequence or in parallel, animations, skills, sequences of animations and/or skills, or any other pieces of functionality. This “stitching together” may be done by pre-processing the data stream or by examining it as it arrives from the data source and creating the sequences on-the-fly, in real time. By way of example but not limitation, if the tiptoeing model (detailed as an example above) were to run into a toy on the ground, the music engine could play out a stubbed-toe animation, trigger a skill that animates the toy to skitter across the floor, and change the system state such that the parent characters wake up and come downstairs to investigate.

The data stream may be bi-directional—that is, the music engine may send data “upstream” to the source of the data stream. By way of example but not limitation, if the author of a game is debugging the system and wants to view a particular scenario over again, the music engine may note that the system is “rewinding” and send appropriate timing information back to the data source (which may or may not ignore the timing information) such that the data source can stay synchronized with the character system. By way of additional example but not limitation, in the above example wherein the tiptoeing model trips on a toy and the music engine triggers a series of events, the music engine may send some data upstream to the data source requesting various sound effects such as a trip sound effect, a toy-skittering-on-the-ground sound effect, and a light-click-on-and-parents-coming-downstairs sound effects.

While, in the above examples, the data stream is of a musical nature, the music engine may respond to an arbitrary data stream. By way of example but not limitation, a user may be creating a data stream by moving a slider in an arbitrary application or tool (mixing board). The music engine might use this data stream to change the color of the sunset or to increase the odds of a particular team winning the baseball game. In either case, the music engine does not require the data stream to be of a musical nature.

2.4 Cinema Engine

The AI Engine uses a custom system for camera behaviors. Each camera is a behavior character that has the ability to compose shots as a part of its “skills”.

2.5 Behavior Engine

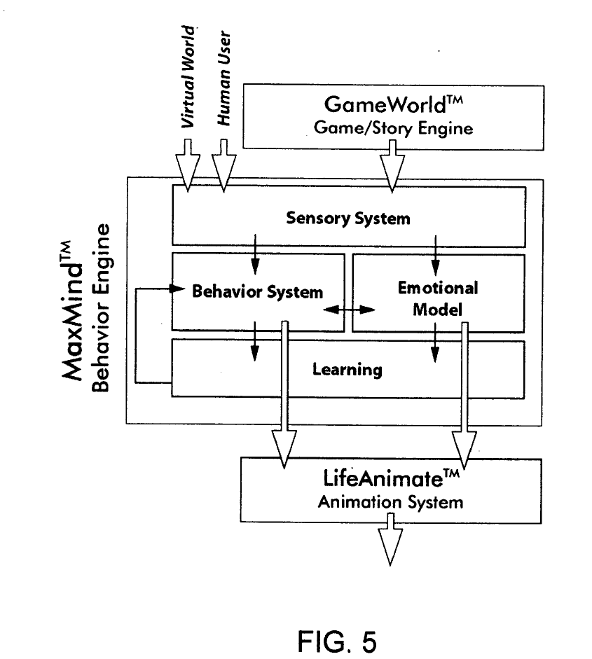

FIG. 5 is a schematic diagram providing a high level description of the functionality of the behavior engine. The arrows represent flow of communication. Each active boundary between the components is defined as a software interface.

The runtime structure of the AI Engine can be represented as a continuous flow of information. First, a character's sensory system gathers sensory stimuli by sampling the state of the virtual world around the character and any input from the human user, and cues from the story engine. After filtering and processing this data, it is passed on to the character's emotional model and behavior selection system. Influenced by sensory and emotional inputs, the behavior system determines the most appropriate behavior at that particular moment, and passes this information along to both the learning subsystem and the animation engine. The learning subsystem uses the past history and current state of the creature to draw inferences about appropriate future actions. The animation engine is in charge of interpreting, blending, and transitioning between motions, and ensures that the character performs its actions in a way that reflects the current state of the world and the character's emotions. Finally, the output of the animation engine is sent to a graphics subsystem which renders the character on the user's screen.

2.5.1 Sensory System

Even though it would be possible to give each creature complete information about the world it lives in, it is highly undesirable to do so. Creatures must maintain “sensory honesty” in order for their behavior to be believable. Just as real creatures cannot collect perfect information about the environment around them, virtual creatures should face the same difficulty. A large amount of “natural” behavior stems from the division between the world and the creature's representation of it. The purpose of the sensing system is to populate this gap.

2.5.2 Behavior System

The behavior system is the component that controls both the actions that a character takes and the manner in which they are performed. The actions undertaken by a character are known as behaviors. When several different behaviors can achieve the same goal in different ways, they are organized into behavior groups and compete with each other for the opportunity to become active. Behaviors compete on the basis of the excitation energy they receive from their sensory and motivational inputs.

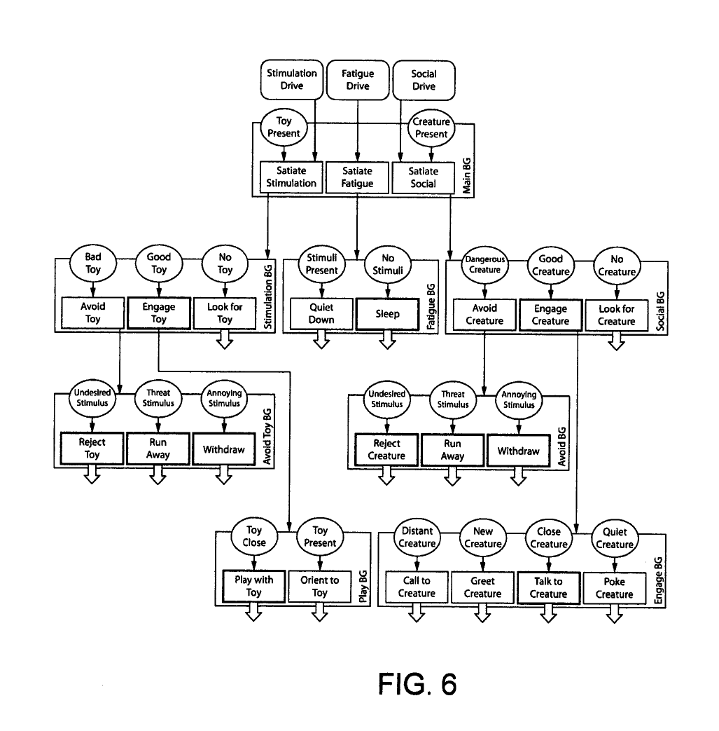

FIG. 6 is a schematic diagram providing a high level description of the behavior hierarchy of a character. Boxes with rounded corners represent drives (top of the image). Circles represent sensory releasers. Gray boxes are behavior groups while white boxes are behaviors. Bold boxes correspond to consummatory behaviors within the group. Simple arrows represent the flow of activation energy. Large gray arrows represent commands sent to the animation engine.

2.5.3 Emotional Model

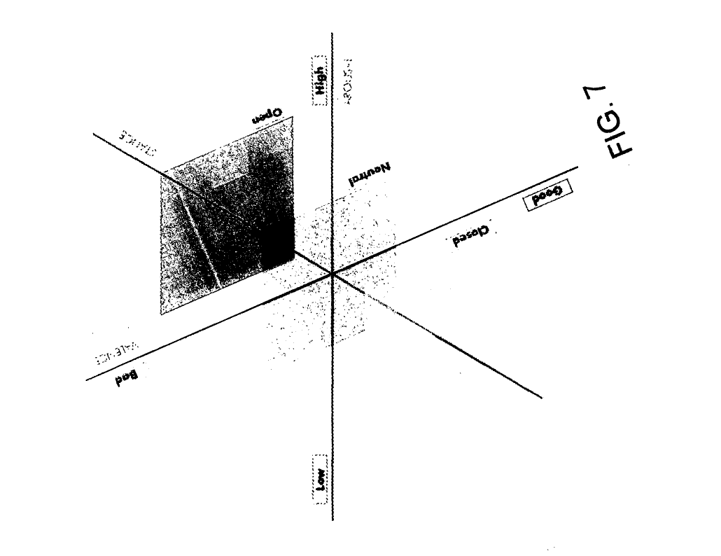

Each creature displays ten cardinal emotions: joy, interest, calmness, boredom, sorrow, anger, distress, disgust, fear and surprise. The present invention defines a three-dimensional space that can be partitioned into distinct regions that correspond to the individual emotions. It is organized around the axes of Arousal (the level of energy, ranging from Low to High), Valence (the measure of “goodness”, ranging from Good to Bad), and Stance (the level of being approachable, ranging from Open, receptive, to Closed, defensive). By a way of example but not limitation, high energy and good valence corresponds to Joy, low energy and bad valence corresponds to Sorrow, and high energy and bad valence corresponds to Anger. FIG. 7 illustrates this approach.

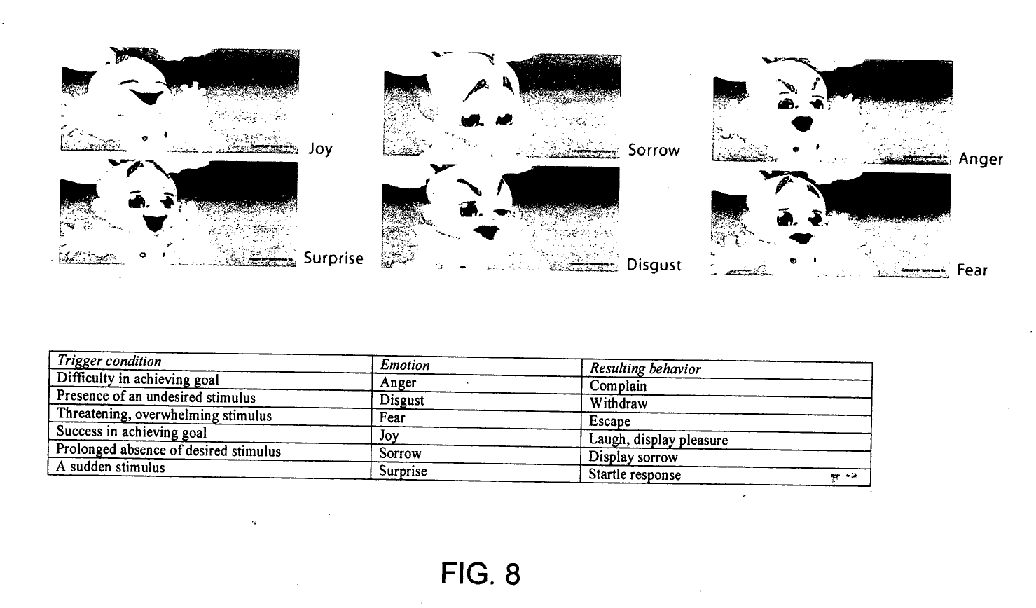

All emotions arise in a particular context, and cause the creature to respond in a particular manner. FIG. 8 lists the trigger condition, the resulting behavior, and the behavioral function for six of the ten cardinal emotions.

2.5.4 Learning

In order to be compelling over extended periods of time, it is important that a character learn from the past and apply this knowledge to its future interactions. The goal of the learning system is to enable characters to learn things that are immediately understandable, important, and ultimately meaningful to the people interacting with them.

2.6 Animation Engine

The animation engine is responsible for executing the chosen behavior through the most expressive motion possible. It offers several levels of functionality:

(i) Playback—the ability to play out hand-crafted animations, such as “walk”;

(ii) Layering—the ability to layer animations on topof one another, such “wave hand” on top of “walk” to generate a walking character waving its hand;

(iii) Blending—it must support motion blending animations, such that blending “turn right” and “walk” will make the character turn right while making a step forward; and

(iv) Procedural motion—the animation engine must be able to generate procedural motion, such as flocking of a number of separate characters.

The behavior system sends requests for motor commands on every update. The animation engine interprets them, consults with the physics and calculates the updated numerical values for each moving part of the character.

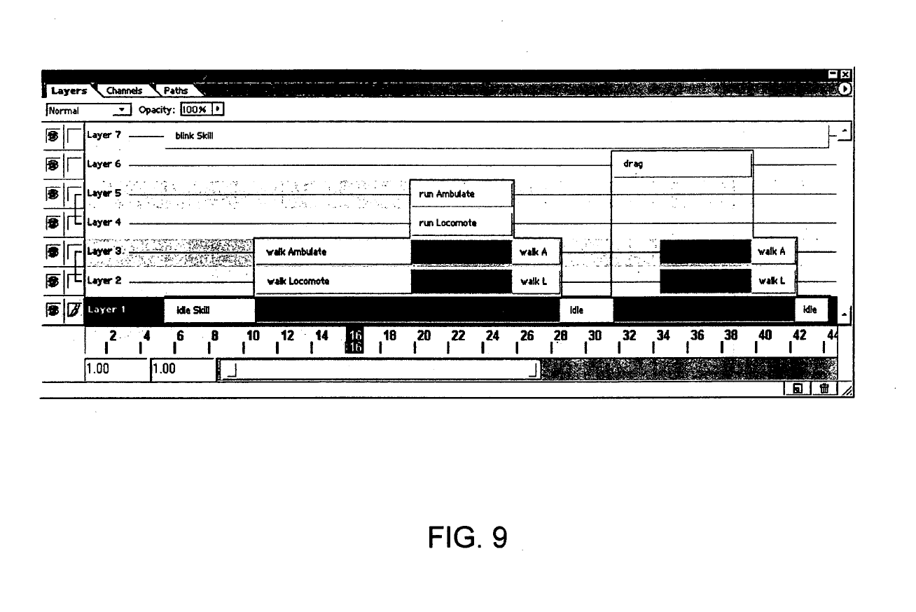

The authoring of complex animation and blending sequences is possible because of a layered animation model within the Animation Engine. See FIG. 9. This model is inspired by the Adobe Photoshop model of compositing images from layers, with the following differences:

(i) animation data is used instead of pixels; and

(ii) the resulting composite is a complex motion in time instead of an image.

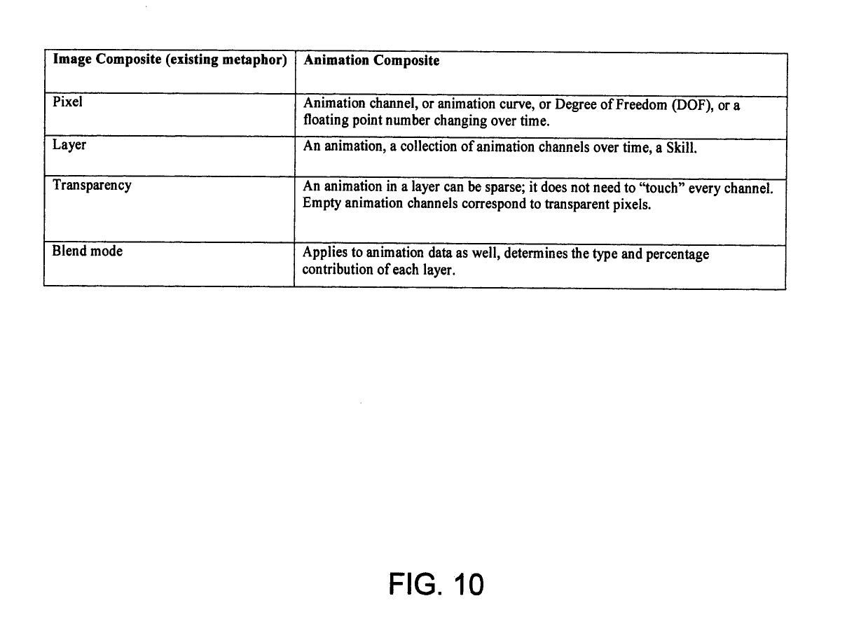

In order to clarify the functionality of the system, it is useful to extend this metaphor further. See FIG. 10.

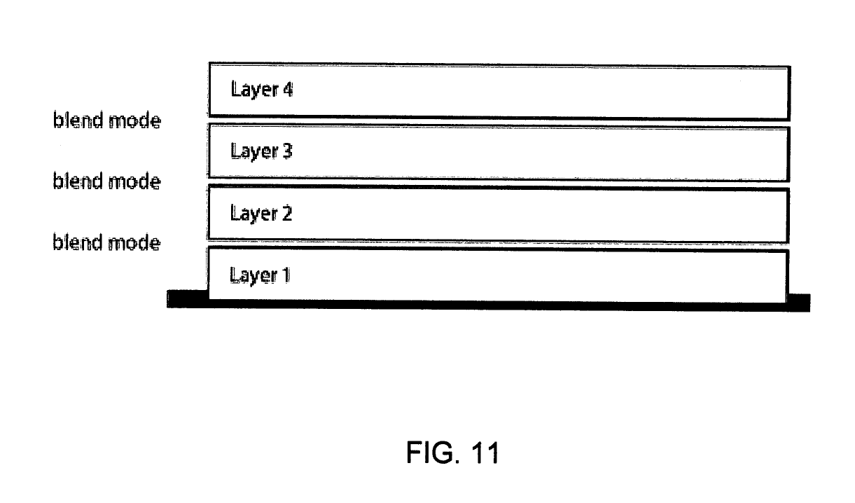

1. Layers (see FIG. 11)

a. Layers are ordered. Each Layer adds its influence into the composite of the Layers below.

b. Each Layer contains Skills (animations).

c. Each Skill belongs to one Layer only.

d. A Layer has only one active Skill at a time, except in case of transitions when two Skills are being cross-faded.

e. If a Skill starts other Skills (GroupSkill, SequenceSkill), it can only do so for Skills in Layers below its own. A Skill can never start a Skill “above” itself.

f. Neighboring Layers have a Blend Mode between them.

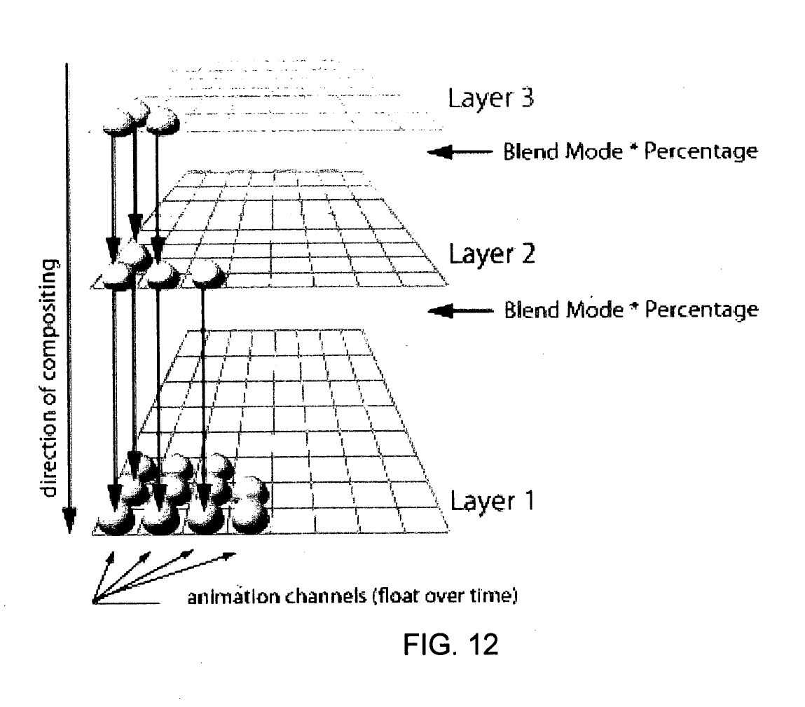

2. Blend Mode (See FIG. 12)

a. Describes how the current layer adds its influence on the composite of all the layers below it.

b. Consists of Type and Amount (Percentage)

c. Some Preferred Types:

i. Subsume (if at 100%, such active skill subsumes all skills in layers below its own); and

ii. Multiply (multiplies its own influence onto the layers below).

3. Group Skills

a. GroupSkills are groups of skills.

b. Some preferred GroupSkills:

i. EmotionGroupSkill

1. Holds onto other Skills that each have an emotional coloring. Emotion and child skill can be mapped.

ii. ParallelGroupSkill

1. Holds onto a bag of skills and executes them upon starting.

2. Remembers whom it started and cleans up upon getting interrupted (upon stop ( ) being called).

iii. SerialGroupSkill

1. Holds onto a bag of skills and executes them one after another (in sequence) remembers.

2. Remembers whom it started and cleans up upon getting interrupted (upon stop ( ) being called).

iv. AmbuLocoGroupSkill

1. Contains an AmbulateSkill (computing the motion of the root node).

2. Contains a LocomoteSkill (animation, e.g., the walk cycle).

3. Is responsible for communicating the parameters of the Locomote to the Ambulate mechanism (like forward speed inherent in the animation cycle).

4. Locomote Skill is any skill, e.g., an EmotionGroupSkill, which means that changes of emotion happen “under the hood”; also, the AmbuLocoGroup needs to communicate the parameters based on which subskill of the locomote group skill is running (in other words, it has to poll locomote often).

4. Relation to the Behavior Engine.

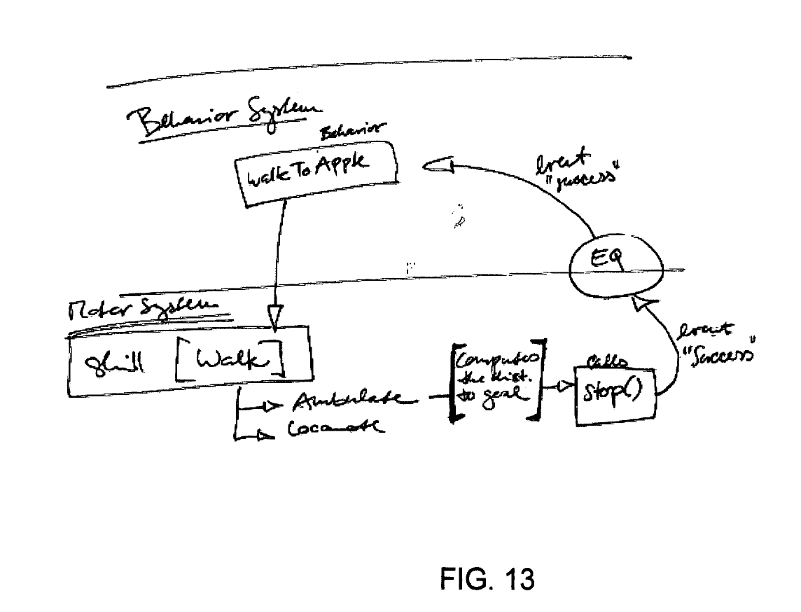

The Animation Engine invariably arrives at information that is necessary for the Behavior Engine, for example, if a Skill WalkTo(Tree) times out because the character has reached the Tree object, the Behavior Engine must be notified. This flow of information “upwards” is implemented using an Event Queue. See FIG. 13.

a. Behavior System actuates a skill, e.g., Walk-To(Tree).

b. The Behavior will be waiting on a termination event, e.g., “SUCCESS”.

c. The relevant AmbulateSkill will compute success, e.g., has the creature reached the object Tree?

d. If so, the MotorSystem will post an event “SUCCESS: Has reached object: Tree” to the Behavior Engine (through an Event Queue).

e. The Behavior will either:

i. Hear “SUCCESS”, stop waiting and adjust the Emotional state, e.g., be Happy;

ii. Or, not hear it in time, timeout, and post failure (unhappy or frustrated). It also stops the ambulate skill, so that the creature does not stay stuck looking for Tree forever.

2.7 AI Graph Data Structure

The AI Engine relies on a complex internal data structure, the so-called “AI Graph”. The AI Graph contains all behavior trees, motion transition graphs, learning networks, etc. for each of the characters as well as functional specifications for the world and the cameras. The AI Engine traverses the AI Graph to determine the update to the graphical character world. The AI Engine also modifies the AI Graph to accommodate for permanent changes (e.g., learning) in the characters or the world. For more information, refer to Section 7.0 Three-Tiered Data Architecture.

3. .ing File Format

3.1 Basic Functionality

The .ing file format is essentially the AI Graph written out to a file. It contains all character, world and camera behavior specification. The .ing file format is a flexible, extensible file format with strong support for versioning. The .ing file format is a binary file format (non-human readable).

3.2 File Content

The .ing file contains all of the information inherent in the AI Graph.

4. The AI Player

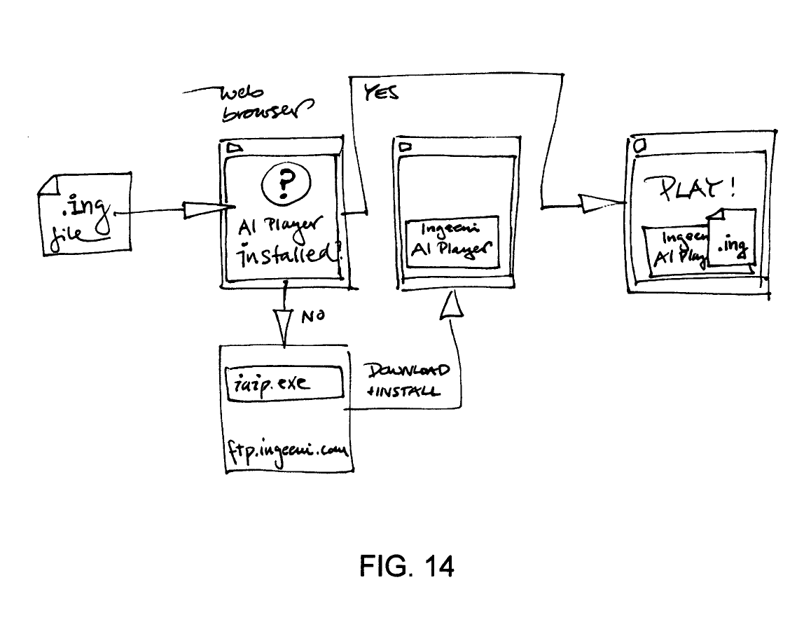

FIG. 14 is a schematic diagram providing a high level description of the functionality of the AI Player.

4.1 Basic Functionality

The AI Player is a shell around the AI Engine that turns it into a plugin to a Web browser. The AI Player is a sophisticated piece of software that performs several tasks:

(i) it reads the .ing file;

(ii) it uses the AI Engine to compute the character's behavior based on user interaction; and

(iii) it connects to a graphics adapter and directs the rendering of the final animation that is visible to the end user.

The AI Player also includes basic maintenance components, such as the mechanism for the AI Player's version updates and the ability to prompt for, and verify, PowerCodes (see below) entered by the user to unlock components of the interaction (e.g., toy ball, book, etc.).

4.2 Overall Design

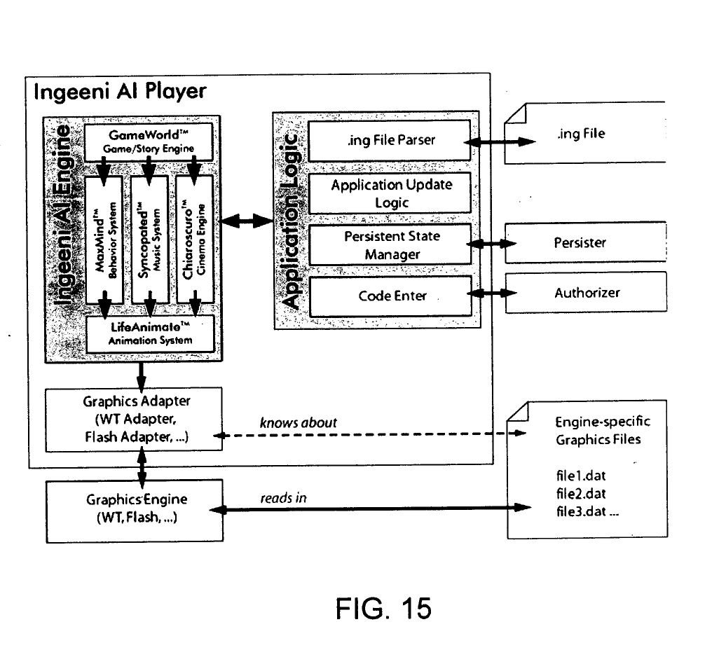

The overall AI Player design is shown in FIG. 15.

The AI Engine forms the heart of the AI Player. The AI Engine's animation module connects directly to a Graphics Adapter which, in turn, asks the appropriate Graphics Engine (e.g., Wild Tangent™, Flash™, etc.) to render the requested animation.

The Graphics Adapter is a thin interface that wraps around a given graphics engine, such as WildTangent™ or Flash™. The advantage of using such an interface is that the AI Player can be selective about the way the same character renders on different machines, depending on the processing power of a particular machine. For low-end machines, the Flash™ graphics engine may provide a smoother pseudo-3D experience. High-end machines, on the other hand, will still be able to benefit from a fully interactive 3D environment provided by a graphics engine such as WildTangent™.

Furthermore, the different graphics engines (Flash™, WildTangent™, etc.) have different data file requirements. Flash™, for example, requires a number of independent flash movie snippets, whereas the WildTangent™ engine requires 3D model files. The corresponding graphics adapters know the file structure needs for their graphics engines and they are able to request the correct graphics data files to be played out.

Finally, having different graphics engines wrapped in the same graphics adapter interface allows for easy expansion of the number of supported graphical engines in the future. If the need arises to create a hybrid graphics engine later on, this can be done and it can be integrated seamlessly with the AI Player.

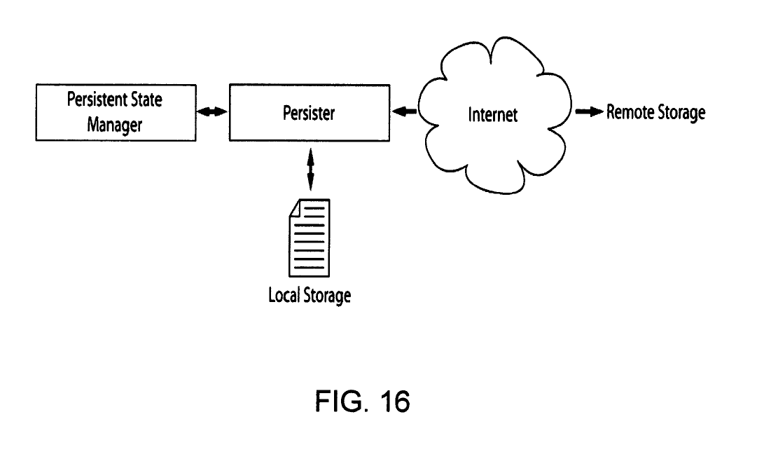

The AI Engine relies on two other pieces of code within the AI Player itself—the Persistent State Manager and the Persister. The Persistent State Manager tracks and records changes that happen within the original scene during user interaction. The Persistent State Manager monitors the learning behavior of the character as well as the position and state of all objects in the scene. How the manager stores this information depends entirely on the Persister. The Persister is an interchangeable module whose only job is to store persistent information. For some applications, the Persister will store the data locally, on the user's hard drive. For other applications, the Persister will contact an external server and store the information there. By having the Persister as an external module to the AI Player, its functionality can be modified without modifying the AI Player, as shown in FIG. 16.

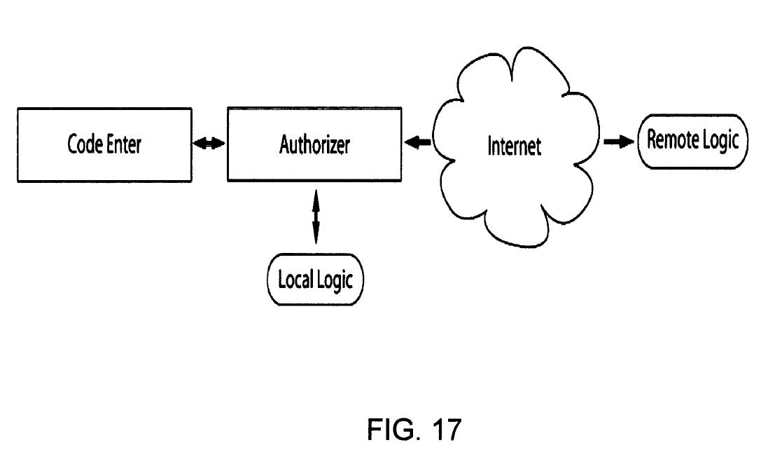

The Code Enter and Authorizer components are two other key components of the AI Player. Any character or object in the scene has the ability to be locked and unavailable to the user until the user enters a secret code through the AI Player. Hence, characters and scene objects can be collected simply by collecting secret codes. In order to achieve this functionality, the AI Player contains a piece of logic called Code Enter that allows the AI Player to collect a secret code from the user and then connect to an external Authorizer module in order to verify the authenticity of that secret code. Authorizer, on the other hand, can be as simple as a small piece of logic that authorizes any secret code that conforms to a predefined pattern or as complex as a separate module that connects over the Internet to an external server to authorize the given code and expire it at the same time, so it may be used only once. The exact approach to dealing with secret codes may be devised on an application-by-application basis, which is possible because of the Authorizer modularity. The interaction between the Authorizer and Code Enter is depicted in FIG. 17.

4.2.1 User Input

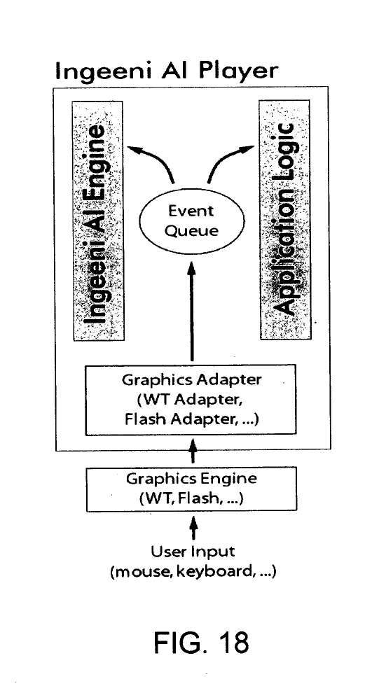

Since each graphics engine is the rendering end point of the character animation, it is also the starting point of user interaction. It is up to the graphics engine to track mouse movements and keyboard strokes, and this information must be fed back into the AI logic component. To solve this problem, an event queue is used into which the graphics adapter queues all input information, such as key strokes and mouse movements. The main player application has a list of registered event clients, or a list of the different player modules, all of which are interested in one type of an event or another. It is the main player application's responsibility to notify all the event clients of all the events they are interested in knowing about, as shown in FIG. 18.

4.2.2 Code Structure and Organization

For ease of development as well as ease of future modifications, it is desirable the structure of the code be rigid and well defined. Careful layering of the code provides this. The AI Player code is organized into layers, or groups of source code files with similar functionality and use, such that any given layer of code will only be able to use the code layers below it and are unaware of the code layers above it. By utilizing a strong code structure such as this, it is possible to isolate core functionality into independent units, modularize the application, and allow for new entry points into the application so as to expand its functionality and applicability in the future.

4.2.3 Code Layers

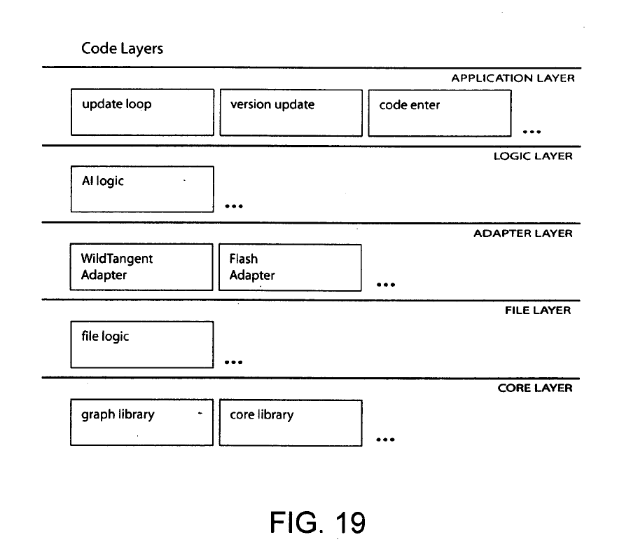

The layers for the AI Player are shown in FIG. 19.

The Core Layer forms the base of all the layers and it is required by all of the layers above it. It administers the core functionality and data set definitions of the AI Player. It includes the Graph Library containing classes and methods to construct scene graphs, behavioral graphs, and other similar structures needed to represent the character and scene information for the rest of the application. Similarly, it contains the Core Library which is essentially a collection of basic utility tools used by the AI Player, such as event handling procedures and string and IO functionality.

The File Layer sits directly on top of the Core Layer and contains all file handling logic required by the application. It utilizes the graph representation structures as well as other utilities from the Core Layer, and it itself acts as a utility to all the layers above it to convert data from files into internal data structures. It contains functions that know how to read, write, and interpret the .ing file format.

The Adapter Layer defines both the adapter interface as well any of its implementations. For example, it contains code that wraps the adapter interface around a WildTangent™ graphics engine and that allows it to receive user input from the WildTangent™ engine and feed it into the application event queue as discussed above.

The Logic Layer contains the AI logic required by the AI Player to create interactive character behaviors. The AI Logic Module is one of the main components of the Logic Layer. It is able to take in scene and behavior graphs as well as external event queues as input and compute the next state of the world as its output.

The Application Layer is the top-most of the layers and contains the code that “drives” the application. It consists of modules that contain the main update loop, code responsible for player versioning, as well as code to verify and authorize character unlocking.

4.2.4 Application Programming

Interface (API)

The system of code layering opens the possibility of another expansion in the AI Player's functionality and use. It allows the AI Player's API to be easily exposed to other applications and have them drive the behavior of the player. It will permit Java, Visual Basic or C++ APIs to be created to allow developers to use the AI Player's functionality from their own code. In this way, complex functionality is introduced “on top of” the AI Player. Custom game logic, plot sequences, cut scenes, etc. can be developed without any need to modify the core functionality of the AI Player.

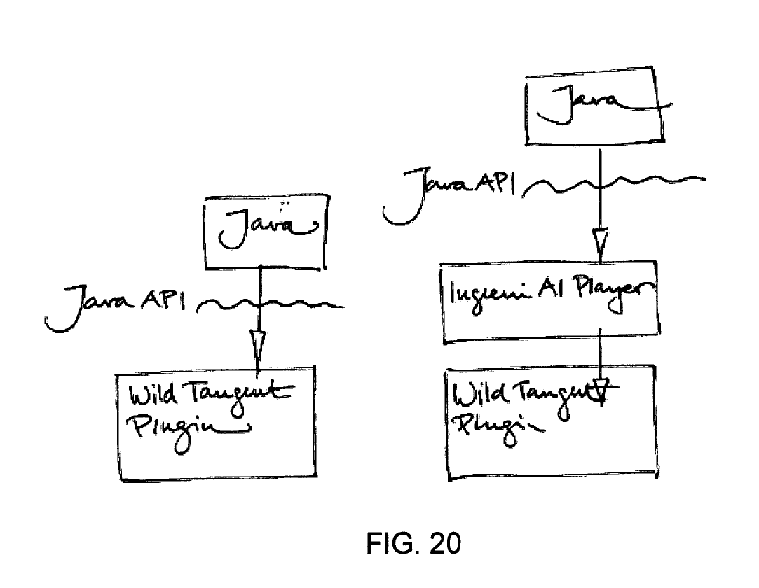

FIG. 20 shows a parallel between (i) the architecture of the WildTangent™ plugin, and (ii) the architecture of the AI Player together with WildTangent™ graphics. WildTangent™ currently allows Java application programming through its Java API. The AI Player becomes another layer in this architecture, allowing the developer to access the AI functionality through a similar Java API.

4.3 Platforms/Compatibility

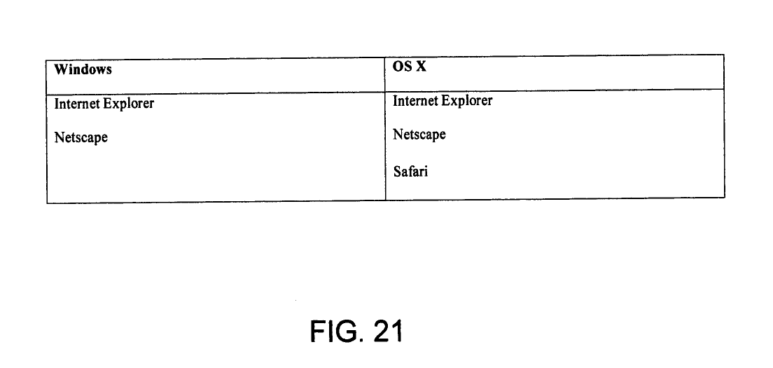

The AI Player will run on the Windows and OSX operating systems, as well as across different browsers running on each operating system. By way of example, but not limitation, the AI Player will run on the following platforms: Windows/Internet Explorer, Windows/Netscape, OSX/Internet Explorer, OSX/Netscape, OSX/Safari, etc. See FIG. 21.

5. Studio Tool

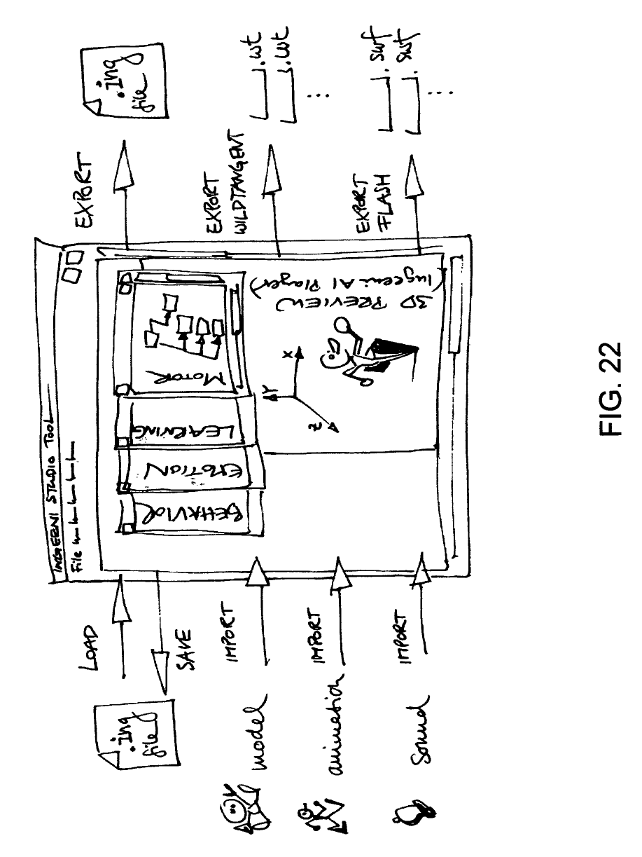

FIG. 22 is a schematic diagram providing a high level description of the functionality of the platform's Studio Tool.

5.1 Basic Functionality

The Studio Tool is a standalone application, a graphical editing environment that reads in data, allows the user to modify it, and writes it out again. The Studio Tool reads in the .ing file together with 3D models, animations, textures, sounds, etc. and allows the user to author the characters' AI through a set of Editors. A real-time preview is provided to debug the behaviors. Finally, the Studio Tool allows the user to export the characters' AI as an .ing file, together with all necessary graphics and sound in separate files.

5.2 .ing Read/Write

The Studio Tool needs to read and write the .ing file format. Together with the .ing specification, there is a Parser for .ing files. The Parser reads in an .ing file and builds the AI Graph internal data structure in memory. Conversely, the Parser traverses an AI Graph and generates the .ing file. The Parser is also responsible for the Load/Save and Export functionality of the Studio Tool.

5.3 Importers

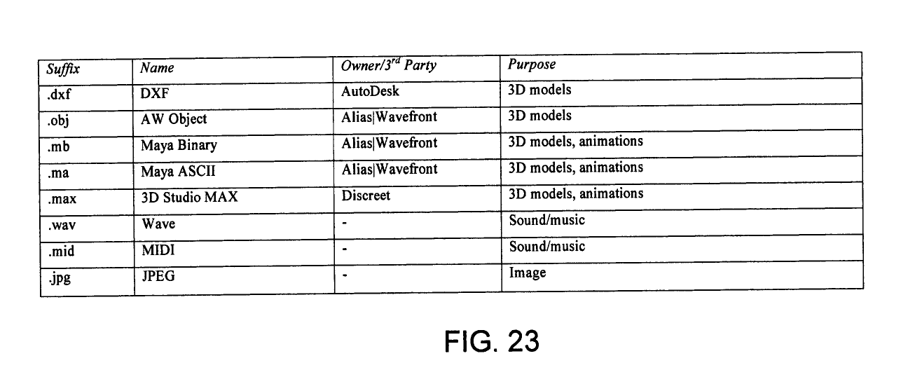

In addition to reading the .ing file, the Studio Tool imports 3rd party data files that describe 3D models for the characters, objects and environments, animation files, sound and music files, 2D texture maps (images), etc. These file formats are industry standard. Some of the file format choices are listed in FIG. 23.

The list of importers is intended to grow over time. This is made possible by a using a flexible code architecture that allows for easy additions of new importers.

5.4 GUI Editors

In essence, the behavior of any character is defined by graphs—networks of nodes and connections, representing states and transitions between states respectively. The authoring process thus involves creating and editing such graphs. There are different types of graphs that represent behavior trees, sensory networks, learning equations, and motor transition graphs. Each graph type has a Graphical User Interface (GUI) Editor associated with it. Each Editor supports “drag and drop” for nodes and connections, typing in values through text boxes, etc. All changes made to the AI graphs are immediately visible in the behavior of the character as shown in the Real-Time Preview window.

5.4.1 Sensors

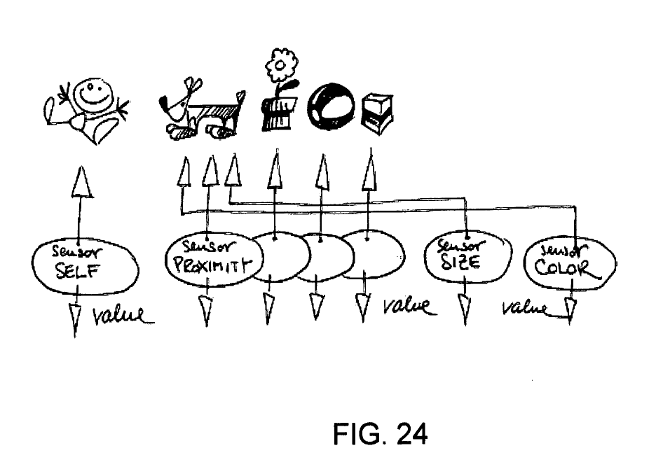

Sensors are nodes that take in an object in the 3D scene and output a numerical value. For example, a proximity Sensor constantly computes the distance between the character and an object it is responsible for sensing. The developer must set up a network of such connections through the Sensor Editor. See FIG. 24.

5.4.2 Behaviors

Behavior trees are complex structures that connect the output values from Sensors, Drives and Emotions to inputs for Behaviors and Behavior Groups. Behaviors then drive the Motor System. A behavior tree is traversed on every update of the system and allows the system to determine what the most relevant action is at any given moment. The developer needs to set up the behavior trees for all autonomous characters in the 3D world through the Behavior Editor.

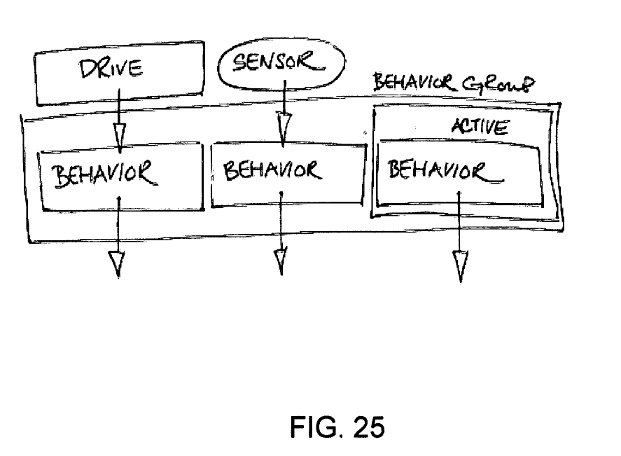

Behavior trees can often be cleanly subdivided into subtrees with well defined functionality. For example, a character oscillating between looking for food when it is hungry and going to sleep when it is well fed can de defined by a behavior tree with fairly simple topology. Once a subtree that implements this functionality is defined and debugged, it can be grouped into a new node that will appear as a part of a larger, more complicated behavior tree. The Behavior Editor provides such encapsulation functionality. See FIG. 25.

5.4.3 Emotions

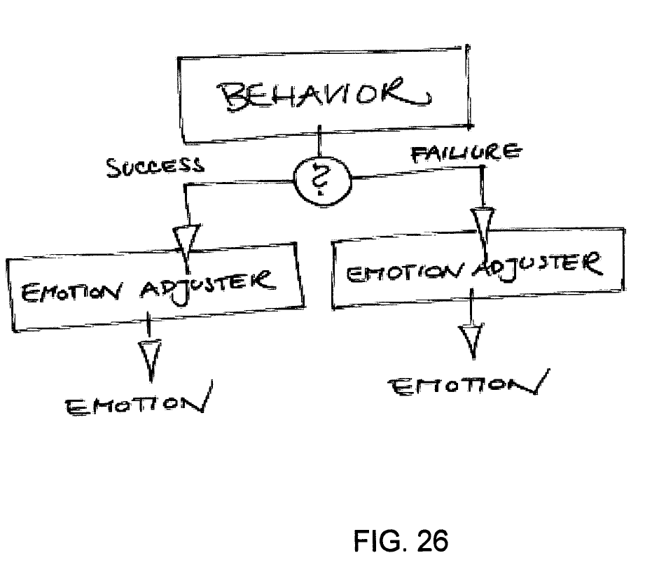

FIG. 26 is a schematic diagram providing a high level description of the functionality of the emotion system.

The Emotion Editor must provide for a number of different functionalities:

(i) Designing how the outcome of different behaviors affects the emotional state of the character;

(ii) Designing how the emotional state affects the character's future choice of behavior; and

(iii) Adjusting the parameters of the given emotional model (e.g., the AVS Emotional Cube, where “AVS” stands for Arousal, Valence, and Stance).

It is important to design and control the complex interplay between the Behavior and Emotion systems. Different Behavior outcomes must affect emotion (e.g., the character just ate lunch and therefore became happy) and, conversely, emotion must affect the choice of behavior (e.g., since the character is happy, it will take a nap). The Emotion Editor allows for the authoring of such dependencies.

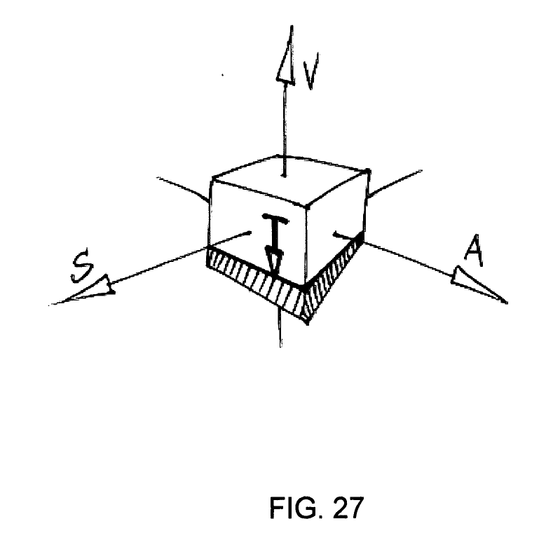

The character will typically follow a fixed emotional model (for example, the AVS emotional cube, see FIG. 27). However, it is important to be able to adjust the parameters of such emotional model (e.g., the character is happy most of the time) as this functionality allows for the creation of personalities.

5.4.4 Learning

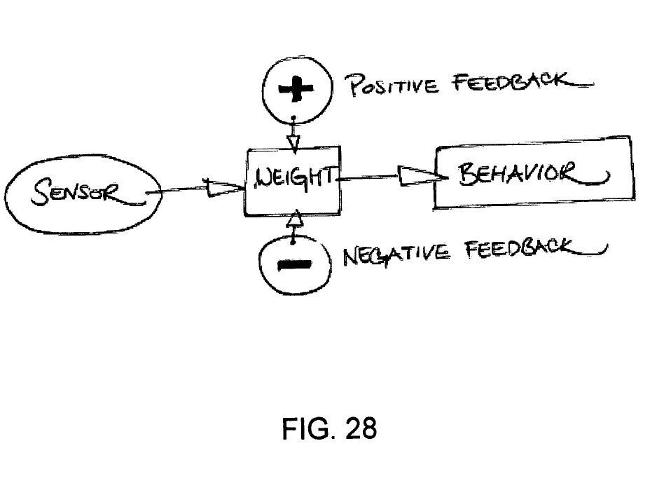

FIG. 28 is a schematic diagram providing a high level description of the learning system.

The Learning Editor must allow the developer to insert a specific learning mechanism into the Behavior graph. A number of learning mechanisms can be designed and the functionality can grow with subsequent releases of the Studio Tool. In the simplest form, however, it must be possible to introduce simple reinforcement learning through the Learning Editor.

5.4.5 Motor System

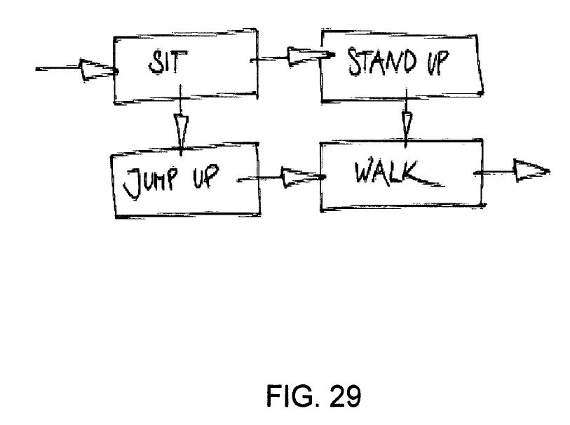

The developer needs to set up a motor transition graph, i.e., a network of nodes that will tell the Motor System how to use the set of animations available to the character. For example, if the character has the “Sit”, “Stand Up” and “Walk” animations available, the Motor System must understand that a sitting character cannot snap into a walk unless it stands up first. See FIG. 29. It is up to the user to define such dependencies using the Motor Editor.

5.5 Real-Time Preview

The Studio Tool allows for an immediate real-time preview of all changes to the character's behavior. This happens in a window with real-time 3D graphics in which the characters roam around. The immediacy of the changes in the characters' behavior is crucial to successful authoring and debugging.

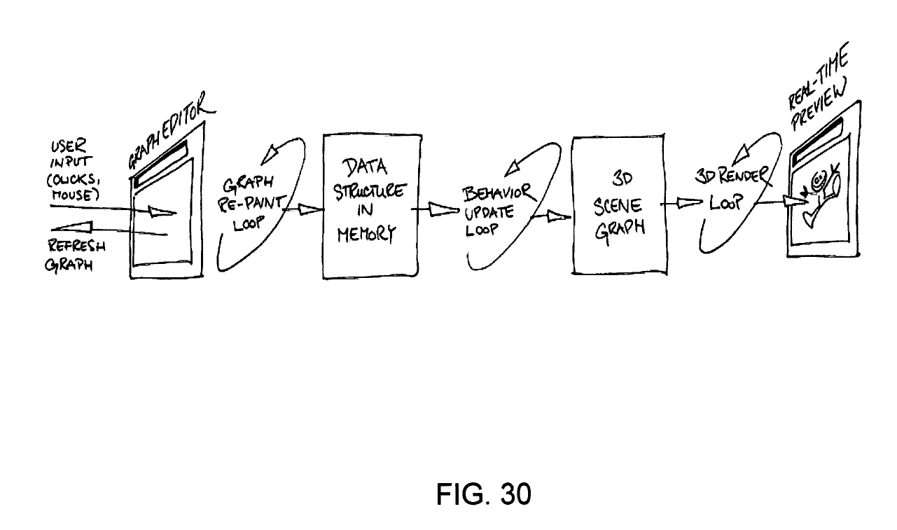

FIG. 30 shows the sequence of updates used to propagate a user change in a character's behavior network all the way through to affect the character's behavior. User input (e.g., click, mouse movement, etc.) is collected in the Graph Editor window and used to interpret the change and to repaint the graph. The change is propagated to the internal data structure that resides in memory and reflects the current state of the system. A behavior update loop traverses this data structure to determine the next relevant behavior. The behavior modifies the 3D scene graph data structure and the 3D render loop paints the scene in the Real-Time Preview window.

The Studio Tool thus needs to include a full real-time 3D rendering system. This may be provided as custom code written on top of OpenGL or as a set of licensed 3rd party graphics libraries (e.g., WildTangent™). The code to synchronize the updates of the internal memory data structure representing the “mind” of the characters with all rendering passes must be custom written.

5.6 Exporters

Once the user designs the behavior specifications for the virtual world and all the characters in it, it is necessary to export the work. The “write” functionality of the .ing parser is used to generate the final .ing file. Separate exporters are used to generate the graphics and sound data files necessary for each of the graphics delivery solutions supported (e.g., WildTangent™, Flash™, etc.). This is done using the file format specifications provided by the parties owning those file formats.

5.7 Platforms/Compatibility

The Studio Tool is designed to run on all operating systems of interest, including both Windows and OSX.

6. Layered AI Architecture

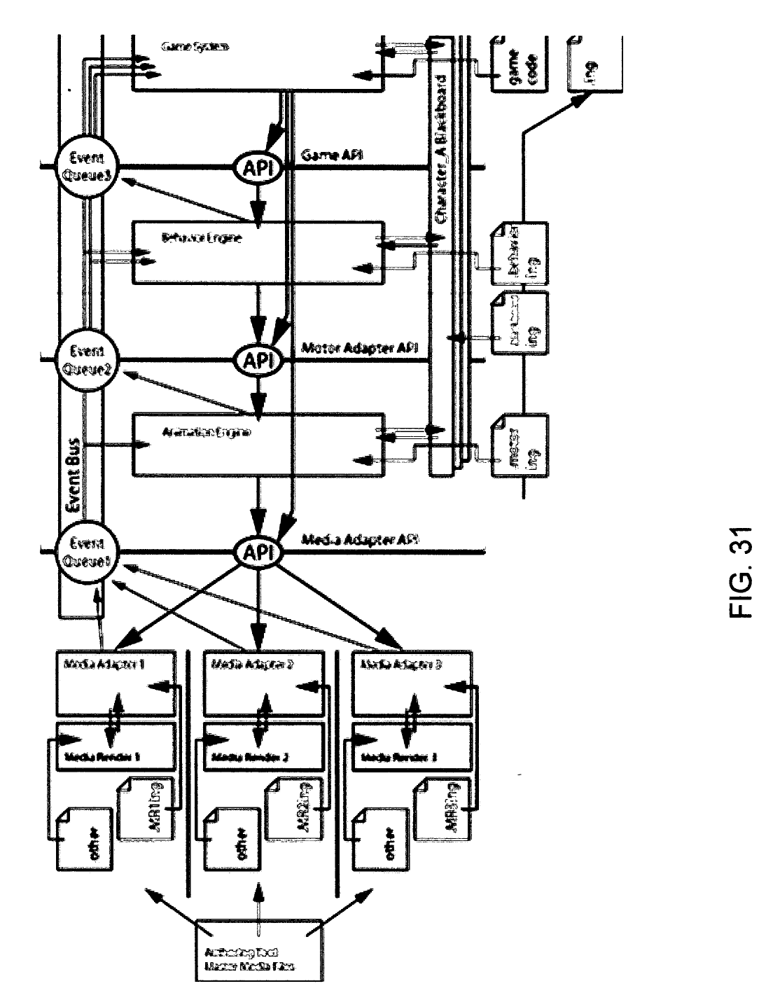

FIG. 31 is a schematic diagram providing a high level description of the system's AI architecture.

The AI Platform is designed to be modular and media independent. The same AI Engine can run on top of different media display devices, such as but not limited to:

3D Graphics Systems (WildTangent, Pulse3D, Adobe Atmosphere, etc.);

2D Graphics Systems (Flash, Director, etc.);

Audio Systems (DirectAudio, etc.);

Robots (Kismet, Leonardo, Space Shuttle, Mars Rover, etc.); and

Animatronic Figures (“Pirates of the Caribbean” theme ride, Terminator, etc.).

This is accomplished by introducing a general MediaAdapter API and a suite of media-specific MediaAdapters that implement it. There is one MediaAdapter for each desired media device. Swapping in different MediaAdapters is extremely easy, a single line change in a page of html code suffices. This introduces high flexibility and reusability of the system.

In case of on-screen animated characters, a typical implementation of the system consists of a GraphicsAdapter and an AudioAdapter. If convenient, these may point to the same 3^{rd} party media display device.

The character media files (3D models, animations, morph targets, texture maps, audio tracks, etc.) are authored in an industry-standard tool (e.g., Maya, 3Dstudio MAX, etc.) and then exported to display-specific file formats (WildTangent .wt files, Macromedia Flash .swf files, etc.). One collection of Master Media Files is used.

The AI Platform descriptor files are exported with each of the display-specific file formats. For example, a .wting file is generated in addition to all .wt files for an export to WildTangent Web Driver™. Equivalently, .FLing files describe Flash media, etc. At runtime, a Media Adapter and a 3^{rd} party Media Renderer are instantiated. The media and media descriptor files are read in.

The AI Engine sits above the Media Adapter API and sends down commands. The Media Renderer generates asynchronous, user-specific events (mouse clicks, key strokes, audio input, voice recognition, etc.) and communicates them back up the chain to all interested modules. This communication is done through an Event Queue and, more generally, the Event Bus.

The Event Bus is a series of cascading Event Queues that are accessible by modules higher in the chain. The Event Queue 1 collects all events arriving from below the Media Adapter API and makes them available to all modules above (e.g., Animation Engine, Behavior Engine, Game Code, etc.). Similarly, The Event Queue 2 collects all events arriving from below the Motor Adapter API and makes them available to all modules above (e.g., Behavior Engine, Game Code, etc.). In this way, the flow of information is unidirectional: each module “knows” about the modules below it but not about anything above it.

The Motor Adapter API exposes the necessary general functionality of the Animation Engine. Because of this architecture, any Animation Engine that implements the Motor Adapter API can be used. Multiple engines can be swapped in and out much like the different media systems. A motor.ing descriptor file contains the run-time data for the Animation Engine.

The Behavior Adapter API exposes the behavioral functionality necessary for the Game Code to drive characters. Again, any behavior engine implementing the Behavior Adapter API can be swapped in. A behavior.ing descriptor file contains the run-time data for the Behavior Engine.

As a result, the API of each module can be exposed as a separate software library. Such libraries can be incorporated into 3^{rd} party code bases.

Each character contains a Blackboard, a flat data structure that allows others to access elements of its internal state. A blackboard.ing descriptor file contains the run-time data for a character's blackboard.

A Game System is a module written in a programming language of choice (e.g., C++, Java, C#) that implements the game logic (game of football, baseball, space invaders, tic-tac-toe, chess, etc.). It communicates with the AI system through the exposed APIs: Game API, Motor Adapter API, and Media Adapter API. It is able to read from the Event Bus and access character blackboards. The files containing game code are those of the programming language used.

If desired, all sub-system .ing data files (e.g., motor, behavior, etc.) for can be collected into a single .ing file. As a result, a full interactive experience preferably as four main types of files:

3^{rd} party media files (e.g., .wt files for WildTangent media);

Media descriptor files (e.g., .WTing descriptor for the WildTangent Graphics Adapter);

AI files (e.g., .ing master file containing all information for behavior, motor, blackboard, etc.); and

Game code files (e.g., Java implementation of the game of tic-tac-toe).

7. Three-Tiered Data Architecture

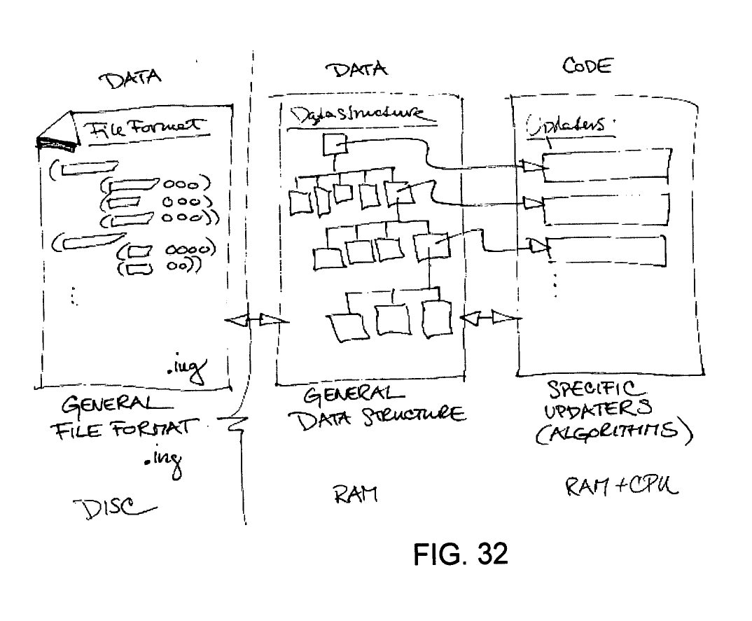

1. Three-Tiered Data Architecture (3TDA) (see FIG. 32).

a. The 3TDA is a general concept which clearly delineates the ideas of:

i. Descriptive Data (a file, network transmission, or other non-volatile piece of descriptive data): Tier I;

ii. Run-Time Data Structure that represents the Descriptive Data: Tier II; and

iii. Functional operations that are applied to or make use of the Run-time Data Structure: Tier III.

b. These three ideas permit a software architecture to be developed:

i. that is file-format independent;

ii. whose data structures are not only completely extensible but also completely independent of the run time functionality; and

iii. whose run time functionality is completely extensible because the run time data structure is simply a structured information container and does not make any assumptions about or enforce any usage methods by the run time functionality.

2. Generic Graph, Behavior Graph, Blackboard, and Neural Nets as example (but not limiting) instances of 3TDA.

a. Generic Graph

i. A generic directed graph can be constructed using the above concepts. Imagine a file format (Tier I) that describes a Node. A node is a collection of Fields, each field being an arbitrary piece of data—a string, a boolean, a pointer to a data structure, a URL, anything. Such a file format could be written as such:

| | |
|---|---|
| (1) | (Node |
| | (Field String “Hello”) |
| | (Field Integer 3) |
| | (Field Float 3.14159) |
| | ) |

ii. A node could also have fields grouped into inputs and outputs—outputs could be the fields that belong to that node, and inputs could be references to fields belonging to other nodes. Example:

```
(1)
  (Node
    (Name Node1)
    (Outputs
      (MyField String “Hello World”)
    )
  )
  (Node
    (Name Node2)
    (Outputs
      (AField String “Hello”)
      (AnotherField Integer 3)
      (YetAnotherField Float 3.14159)
    )
    (Inputs
      (Node1.MyField)
    )
  )
```

iii. By using the above description, a two-node graph is constructed. Just as easily, a 100-node graph could be constructed. Yet nowhere is there any indication of the potential functionality of this graph—it is simply a data structure of arbitrary topological complexity with an arbitrary richness and sophistication of data content (II).

iv. To each node in this graph, one or more Updaters can be attached, stand-alone pieces of functionality (Tier III) that are associated with that node. An updater's job is to take note of a node's fields and anything else that is of importance, and perhaps update the node's fields. For instance, if a node has two numeric inputs and one numeric output, an AdditionUpdater could be built that would take the two inputs, sum them, and set the output to that value. Note that more than one updater can be associated with a single node and more than one node with a single updater. Also, note that 1) the updater has no notion or relationship to the original data format that described the creation of the node, 2) each updater may or may not know or care about any other updaters, and 3) each updater may or may not care about the overall topology of the graph. The updaters' functionality can be as local or as broad in scope as is desired without impacting the fundamental extensibility and flexibility of the system. Which updaters are attached to which nodes can be described in the graph file or can be cleanly removed to another file. Either way, the file/data/functionality divisions are enforced.

v. With such a general graph system, where the data is cleanly delineated from the functional aspects of the graph, some useful examples can be derived.

b. Artificial Neural Network

i. Using a graph as described above, an Artificial Neural Network could be implemented. By describing the data fields in each node as being numeric weights and attaching Updaters such as AdditionUpdater, XORUpdater, AndUpdater, and OrUpdater, a fully functional artificial neural network may be created whose data and functionality are completely separate. That network topology may then be used in a completely different manner, as a shader network, for example, simply by changing the updaters. Note also that the network structure that has been created by the updaters can be saved out to a general file description again (Tier I).

c. Behavior Graph

i. The general graph structure can be used to implement a behavior graph. Each node can be defined to contain data fields related to emotion, frustration, desires, etc. Updaters can then be built that modify those fields based on certain rules—if a desire is not being achieved quickly enough, increase the frustration level. If the input to a desire node is the output of a frustration node, an updater may change the output of the desire node as the frustration increases, further changing the downstream graph behavior.

d. Blackboard

i. A graph may be defined in which none of the nodes are connected—they simply exist independently of one another. In this case, the nodes can be used as a sort of Blackboard where each node is a repository for specific pieces of data (fields) and any piece of functionality that is interested can either query or set the value of a specific field of a specific node. In this manner a node can share data among many interested parties. Updaters are not required in this use Nodes, which shows again that the removal of the updater system (Tier III) in no manner impacts the usefulness of extensibility of the data structure (Tier II) and affiliated file format that describes it (Tier I). Note below where updaters will be used with the blackboard to communicate with the event system.

e. Infinite Detail

i. Because of the data separation, an updater may only be told about some particular fields of a node. Note that, because of this, and because of the fact that a node may have more than one updater, a node may be supported by a potentially arbitrary amount of data. Imagine a creature's behavior graph that contains a node. That node has two inputs relating to vision and sound (eyes and ears) and a single output detailing whether the creature should proceed forward or run away. It is possible to create a separate graph being used as an artificial neural network, and to hide that graph completely inside an updater that is attached to the node. When the updater looks at the node, it takes the value of the two input fields, gives them to it's arbitrarily large neural network that the node, the behavior graph, and the other updaters know nothing about, takes the output value of it's neural network, and sets the walk forward/run away field of the original node to that value. Despite the fact that the original node in the behavior graph only has three fields, it is supported by a completely new and independent graph. And note that the neural net graph could, in turn, be supported by other independent graphs, and so on. This is possible because the data and the functional systems cleanly delineated and are not making assumptions about each other.

3. Event System

a. When something of interest happens in a game or interactive or any other piece of functionality (mouse click, user interaction, system failure, etc), there may be other pieces of functionality that want to know about it. A system can be built that sends events to interested parties whenever something of interest (an event trigger) has happened. A generic event system can be built based on three basic pieces:

i. An event object—an object that contains some data relevant to the interesting thing that just happened.

ii. An event listener—someone who is interested in the event.

iii. An event pool—a clearinghouse for events. Event listeners register themselves with an event pool, telling the event pool which events they are interested in. When a specific event is sent, the event pool retrieves the list of parties interested in that specific event, and tells them about it, passing along the relevant data contained in the event object.

b. A general event system can be built by not defining in advance exactly what events are or what data is relevant to them. Instead, it is possible to define how systems interact with the event system—how they send events and how they listen for them. As a result, event objects can be described at a later time, confident that while existing systems may not understand or even know about the new event descriptions, they will nonetheless be able to handle their ignorance in a graceful manner, allowing new pieces of functionality to take advantage of newly defined events.

i. As an example, imagine two different event types—system events and blackboard events. System events consist of computer system-related event triggers—mouse clicks, keyboard presses, etc. Blackboard events consist of blackboard-related event triggers—the value of a field of a node being changed, for instance. Because the basic manner in which systems interact can be defined with event systems—registering as a listener, sending events to the pool, etc, to create a new event type, only the set of data relevant to the new event has to be defined. Data for mouse events may include the location of the mouse cursor when the mouse button was clicked, data for the blackboard event may included the name of the field that was changed.

ii. Using the blackboard, and even the generic graph detailed above as an example, a graph event could be defined that is triggered when something interesting happens to a graph node. An updater could be used that watches a node and its fields. When a field goes to 0 or is set equal to some value or when a node is created or destroyed, an event can be fired through the newly-defined graph event pool. Systems that are interested in the graph (or the blackboard) can simply register to be told about specific types of events.

When such an event is triggered, the systems will be told about it and passed the relevant information.

8. Business Methodology and Brand Involvement Metrics

8.1 Business Methodology

“One important relationship for many brands is a friendship link characterized by trust, dependability, understanding, and caring. A friend is there for you, treats you with respect, is comfortable, is someone you like, and is an enjoyable person with whom to spend time.” David Aaker, “Building Strong Brands”.

The marketing landscape is changing, bringing to the forefront a need for strengthening the Brand. The present invention provides a means to create a compelling, long-time, one-on-one Brand interaction—between the Brand and the Brand's consumer.

“We cannot sell more packages unless we have entertainment,” Consumer Packaged Goods (CPG) companies are increasingly realizing this dynamic. Children are used to bite-size, videogame-like fast entertainment, and used to food that provides such entertainment with on-package puzzles or in-box toys. Adults are used to food with colorful packaging and co-branding of entertainment properties.

There are two distinct pulls within marketing—Promotions and Branding. There is a tension between the two pulls. On the one hand, companies are feeling pressure to increase promotions spending for fast volume lifts. On the other hand, marketers spend large resources on Branding and Communications.

8.1.1 Promotions Marketing

Several changes in the business landscape have made promotions increasingly strategic.

Marketing impact has shifted from TV to retail outlets. People decide on purchases at the shelf rather than in advance.

Wall Street's influence has risen sharply, which often leads to emphasis of short-term sales over long-term branding. Short-term sales increase with promotions, especially premium incentives sold along with the packaged product. The market for premium incentives (such as toys or DVDs included along with the product) was $26 billion in 2001, a quarter of total promotions spending.

Including premiums along with the product has become increasingly simple with new forms of technology (creating plastic toy and digital entertainment).

Companies have responded to these business pressures over the past decade: promotions spending has reached $99 billion in 2001, up from $56 billion in 1991.

8.1.2 Brand Marketing

To increase the frequency and length of customer interactions with their products, marketers are turning to Branding for several reasons.

After studying 100 of the world's most valuable brands, the well-known source of brand valuations Interbrand has concluded that a brand typically accounts for an average of 37% of market capitalization. For example, Interbrand's 2001 Survey names Coca-Cola as having the largest brand value. Coke's brand value was estimated to contribute up to 61% of its $113 billion market capitalization, for a total of $69 billion in brand value. This is used by many in marketing to demonstrate the significance of engaging in brand marketing.

According to McKinsey and Company, “Sustainable, profitable brand growth has become the key objective for most marketing executives.”

Brand marketing becomes more important as an increased variety of channels vie for the viewer's attention, from TV to the Internet to print. While the viewer is bombarded with advertisements, it has been shown that the viewer tends to ignore and bypass such attempts at advertising. For example, 88% of television commercials are skipped by viewers with TiVo boxes. As TiVo and other time-shifting devices proliferate, a dramatically large portion of all advertising dollars goes wasted.

At the same time that people bypass general advertising, a study by Research.net for Forbes.com shows that people, especially high-level executives, seek out branded content. In particular, high-level executives spend on average 16 hours per week on the Internet, compared to 8.6 hours on TV, 5.7 hours on radio, and 6.6 hours on print. “Business leaders, the survey found, respond positively to online advertising, which ranked highest over all other media measured (TV, radio, newspapers, magazines) when they want information on new products and services.”

Both Promotions and Branding are growing in size and influence within an organization as marketers walk the fine line between immediate consumer gratification accomplished through Promotions, and long-term mind-share with the consumer built up through Branding.

8.2 The Artificial Intelligence Solution

The AI Platform answers the needs of both the Promotions and the Branding marketers within each organization. The AI Platform creates long-term interactive characters based on the Brand's own character property. Furthermore, these characters are collectible as part of a long brand-enhancing promotion.

With the present invention, virtual, three-dimensional, intelligent interactive characters may be created. CPG companies with brand mascots, Service companies with brand character champions, and Popular Entertainment Properties that want to bring their character assets to life. For these companies, Interactive Brand Champions (IBCs) (or, equivalently, Interactive Brand Icons (IBIs)) may be created that appear intelligent as they interact with the user and each other. The characters encourage collecting—the more characters are collected, the more interesting the virtual world they create. The characters are delivered to the user's personal computer over the web through a code or a CD-ROM or other medium found on the inside of consumer goods packaging.

The AI Solution based on branded intelligent interactive characters enables an organization to:

1. Develop and strengthen brand identity.

2. Create one-on-one brand value communication channel.

3. Generate continuous, long-term interaction with the brand.

4. Collect precise user statistics.

8.3 Business Applications

In various forms of the invention, there are systems for integrating the novel interactive environment with a commercial transaction system. Applications for the technology and invention can be found, without limitation, in the following:

8.3.1 Embedded Entertainment

The present invention describes a technology system that delivers entertainment through virtual elements within a virtual environment that arrive at the viewers' homes through physical products. Every can of food, bottle of milk, or jar of jam may contain virtual elements. In addition, but without limitation, codes can be accessible from a combination of physical products, such as through a code printed on a grocery store receipt or on a package of food. It is entertainment embedded in the physical product or group of products; it is a marriage of bits (content) and atoms (physical products).

There are different ways in which this can be accomplished, by way of example but not limitation:

a. Alphanumeric code

b. Sensing mechanism

c. Barcode

More particularly, in this form of the invention, a customer might buy a product from a vendor and, as a premium for the purchase, receive a special access code. The customer then goes to a web site and enters the access code, whereupon the customer will receive a new virtual element (or feature for an existing virtual element) for insertion into the virtual environment, thus making the virtual environment more robust, and hence more interesting, to the customer. As a result, the customer is more motivated to purchase that vendor's product.

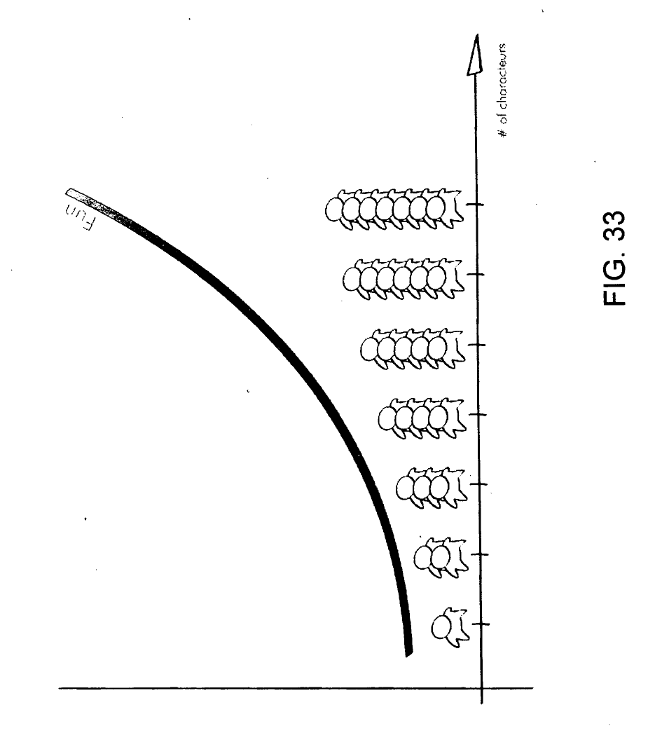

By way of example but not limitation, the XYZ beverage company might set up a promotional venture in which the novel interactive environment is used to create an XYZ virtual world. When customer John Smith purchases a bottle of XYZ beverage, John Smith receives, as a premium, an access code (e.g., on the underside of the bottle cap). John Smith goes home, enters the access code into his computer and receives a new object (e.g., an animated character) for insertion into the XYZ virtual world. As the XYZ world is populated with more and more objects (e.g., characters, houses, cars, roads, etc.), or features for objects (e.g., a skill for an existing character), the XYZ virtual world becomes progressively more robust, and hence progressively interesting, for John Smith. The characters encourage collecting—the more characters are collected, the more interesting the virtual world they create. John Smith is therefore motivated to purchase XYZ beverages as opposed to another vendor's beverages. See FIG. 33.

8.3.2 Interactive Brand Champions

The present invention provides a method of strengthening brand identity using interactive animated virtual characters, called Interactive Brand Champions. The virtual characters are typically (but not limited to) representations of mascots, character champions, or brand logos that represent the brand.

By way of example but not limitation, the XYZ food company or the ABC service company might have a character that represents that brand. The brand character might display some traditionally ABC-company or XYZ-company brand values, such as (but not limited to) trust, reliability, fun, excitement. In this case, a brand champion is created, an animated virtual element that also possesses those same brand values. In particular, but without limitation, the brand characters may belong to CPG companies with brand mascots, Service companies with brand character champions, and Popular Entertainment Properties that want to bring their character assets to life.

The concept of branded intelligent interactive characters enables an organization to:

1. Develop and strengthen brand identity. Through an animated character brand champion, the customer's brand benefits from increased visibility, high technological edge, and increased mind share with the customer.

2. Create one-on-one brand value communication channel. Because the characters exhibit autonomous behavior, emotion and learning, they interact with each user in a way that is unique and personalized. As a result, the organization gains a unique, one-on-one channel of communication between its brand and its target audience.

3. Generate continuous, long-term interaction with the brand. Because the characters learn and adapt to changing conditions and interaction patterns, the user experience remains fresh and appealing for a significantly longer time than previously possible.

4. Collect precise user statistics and determine Brand Involvement. The extent of the promotion can be monitored precisely through statistical analysis of the traffic over applicable databases. This information is compiled and offered to the organization as a part of the service license. In this way, the client can directly measure intangible benefits such as feedback and word of mouth and metrics of Brand Involvement, variables previously impossible to measure.

8.4 Brand Involvement

In order to evaluate each application of the AI Platform, here are several new metrics to measure the success of each particular instantiation of the system. These metrics are called metrics of Brand Involvement as they measure the amount of interaction by the user with the brand character.

Brand Involvement Metrics include, without limitation, the following metrics:

(i) Measure of Ownership. How customized a character does the user create? By a way of example but not limitation, this metric is defined as the dot product of the personality vector of the user's character after a time of interaction and the personality vector of the original character. This metric thus represents the “distance” that the user covered in owning the character.

(ii) Measures of Caregiver Interaction. How emotionally involved is the user with the character? There are two metrics of caregiver interaction: sad-to-happy and time-to-response. By a way of example but not limitation, the sad-to-happy metric is a percentage of the times that a character was sad (or in another negative emotional state) and the user proactively interacted with the character to change the character's state to happy (or to another positive state). The time-to-response metric is the length of time on average before the user responds to the character's needs.

(iii) Measures of Teacher Interaction. How much did the character learn and how much did the user teach? The two metrics observed are number of behaviors modified or changed as a result of interaction and number of times user attempted to correct the character's behavior.

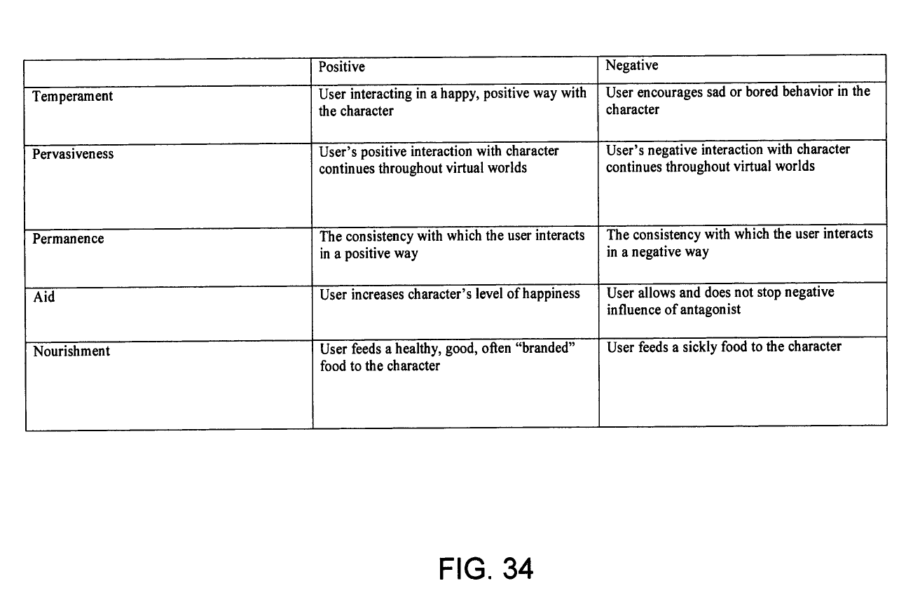

(iv) Measure of Positive-Neutral-Negative Relationship. How much did the user not interact at all (neutral)? A neutral interaction is less preferable in terms of creating a relationship with the brand to that with a positive or negative interaction. Even a negative interaction can reveal interesting elements of the user's desired relationship and boundaries of interacting with the brand. As another measure, how long did the user interact in a positive and in a negative way? These metrics may be measured in a number of ways, including without limitation as percentage of all possible interactions or as degrees of intensity of interaction. FIG. 34 refers to possible positive and negative interactions, as a measure of Brand Involvement.

Thus Brand Involvement can be measured, without limitation, by metrics of 1) ownership, 2) caregiver interaction, 3) teacher interaction, and 4) positive-neutral-negative brand relationship.

9. Modules

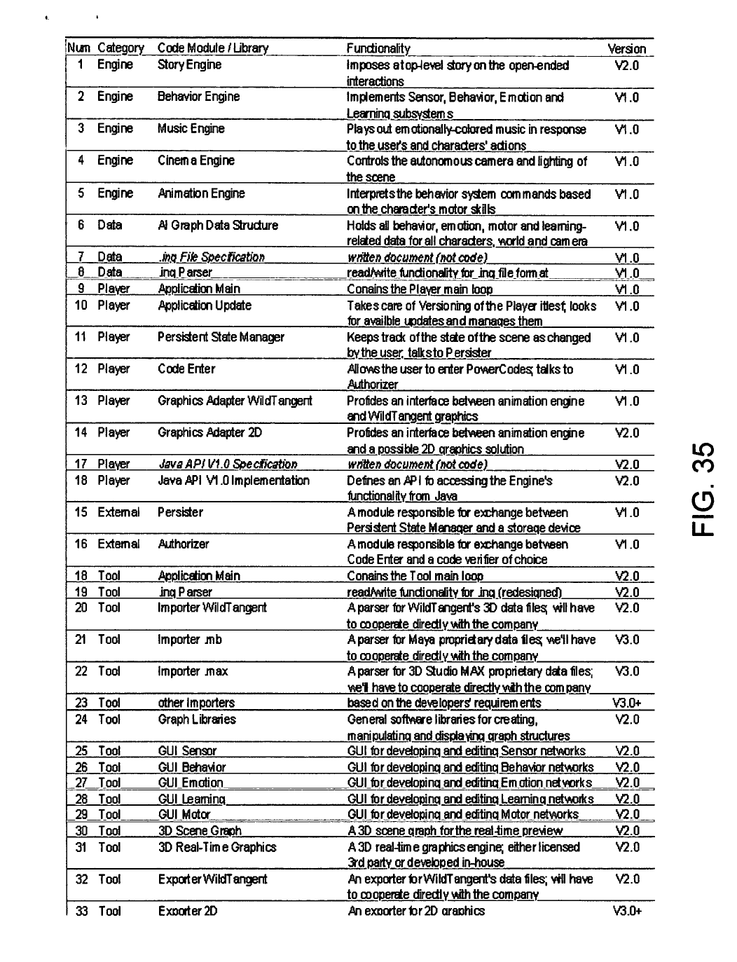

FIG. 35 shows a list of modules utilized in one preferred form of the present invention.

At a minimum, the AI Player provides at least the following functionality:

(i) Installs and runs in a Web browser;

(ii) Reads in an .ing file;

(iii) Builds the AI Graph data structure in memory;

(iv) Executes behaviors as specified in the AI Graph;

(v) Renders finished characters using a graphics engine;

(vi) Reads in graphic engine graphics files, as necessary;

(vii) Drives a graphics engine;

(viii) Takes in a PowerCode, if necessary;

(ix) Verifies a PowerCode, as necessary; and

(x) Keeps track of world state between sessions (combined with user/login databases) as necessary.

10. System Applications

Based on the requirements of the user, it is believed that there are at least three major scenarios in which the novel software platform will be used: CD-ROM release, Web release, and independent authoring and use.

10.1 CD-ROM Release

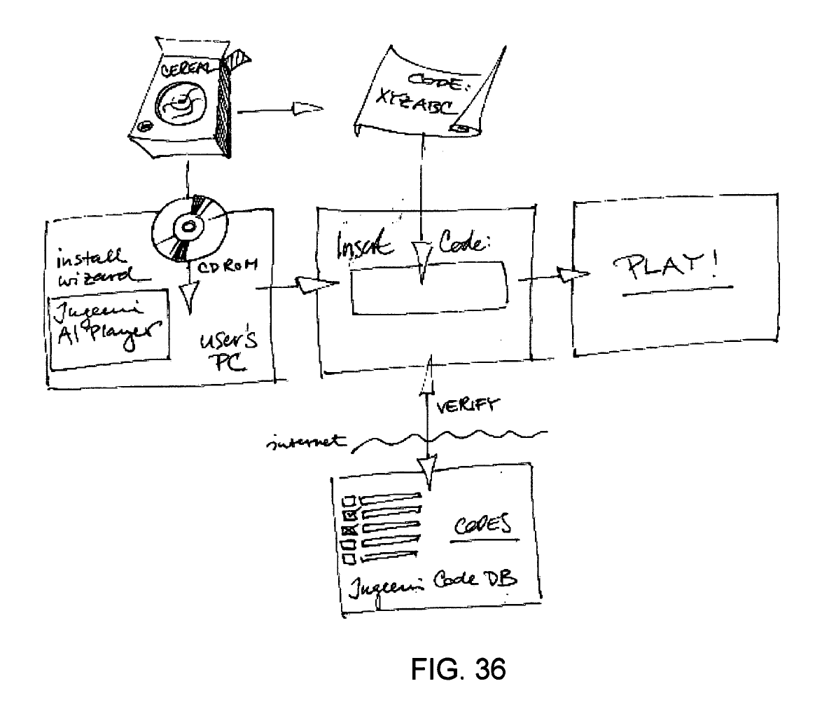

FIG. 36 is a schematic diagram providing a high level description of a CD-ROM release.

In the case of shipping characters on a CD-ROM, the AI Player and all data files must be contained on the CD-ROM and install on the user's computer through a standard install procedure. If the CD-ROM is shipped as a part of a consumer product (e.g., inside a box of cereal), a paper strip with a printed unique alphanumeric code (i.e., the PowerCode) is also included. While the CD-ROM is identical on all boxes of cereal, each box has a unique PowerCode printed on the paper strip inside.

Once the end-user launches the AI Player, he or she can type in the PowerCode to retrieve the first interactive character. The PowerCode may be verified, as necessary, through a PowerCode database that will be hosted remotely. In this case, the user's computer (the “client”) must be connected to the Internet for PowerCode verification. After successful verification, the character is “unlocked” and the user may play with it.

10.2 Web Release

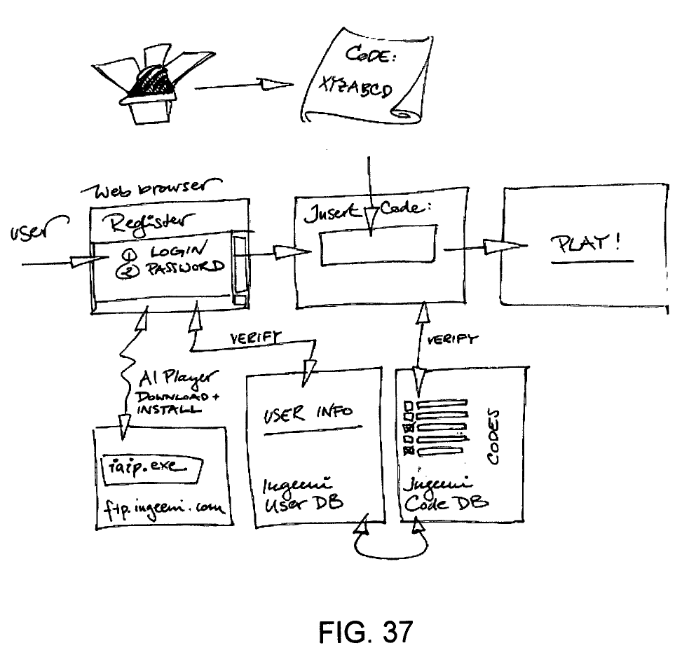

FIG. 37 is a schematic diagram providing a high level description of a Web release.

If the characters are delivered over the Web, the user will need to register and login using a password. Once the browser encounters an .ing file upon login, it downloads and installs the AI Player if not already present. When the user types in a PowerCode, it will be verified in a remote database. After a successful verification, the user can play with a freshly unlocked character.

The characters, collected together with any changes to their state, must be saved as a part of the account information for each user. The information in the user database grows with any PowerCode typed in.

10.3 Authoring and Release

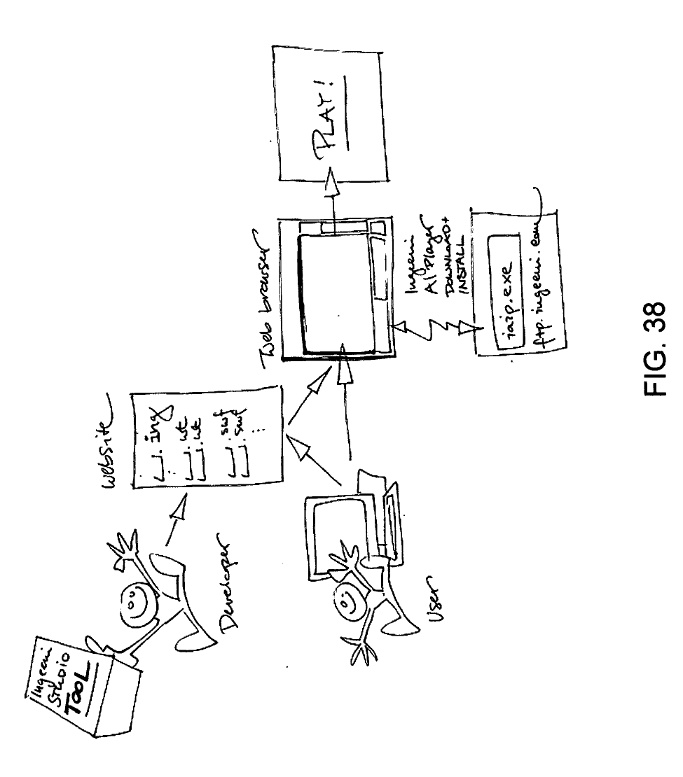

FIG. 38 is a schematic diagram providing a high level description of the authoring and release application scenario.

The Studio Tool makes it possible for any developer to generate custom intelligent characters. The .ing files produced may be posted on the Web together with the corresponding graphics and sound data. Any user who directs their browser to these files will be able to install the AI Player, download the data files and play out the interaction.

10.4 General Model

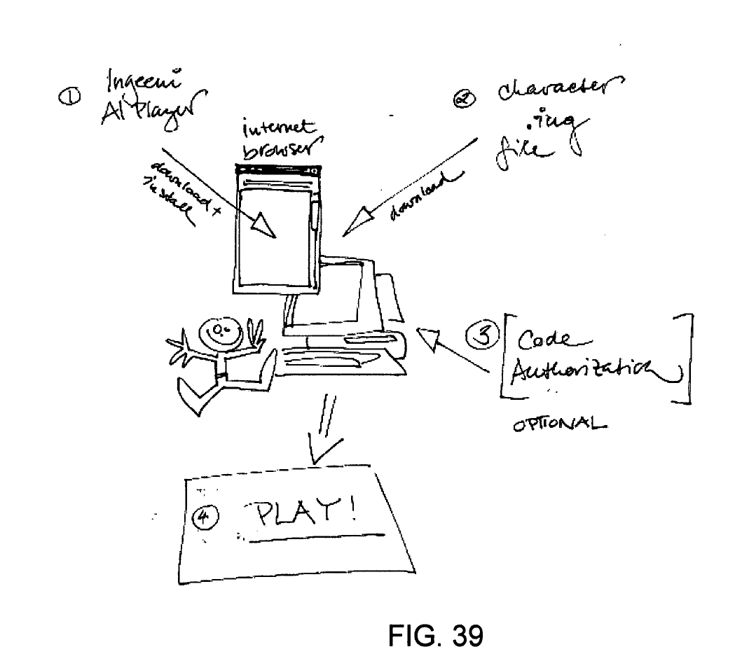

Given the three major scenarios above, it is possible to define a general model describing the system. See FIG. 39. First, upon encountering an .ing file, the AI Player is downloaded and installed in the user's browser. Second, the character .ing file is downloaded. Third, the PowerCode is typed in and authorized. This last step is optional, as many applications may not require it. Finally, the user can play with an intelligent interactive character.

10.5. Commercial Applications

The AI Platform is able to provide a game environment for children of different ages. The game entails a virtual reality world containing specific characters, events and rules of interaction between them. It is not a static world; the child builds the virtual world by introducing chosen elements into the virtual world. These elements include, but are not limited to, “live” characters, parts of the scenery, objects, animals and events. By way of example but not limitation, a child can introduce his or her favorite character, and lead it through a series of events. Since the characters in the AI Platform world are capable of learning, the underlying basic rules defining how the characters behave can change, causing the game to be less predictable and therefore more fascinating to a child. By introducing more and more characters to his or her virtual world and subjecting them to various events, a child can create a fascinating world where characters “live their own lives”.

The game provides the opportunity for the constant addition of new characters, elements or events by the child. Because this causes the game to be more robust, children will tend to have the desire to add new elements to the AI world.

A child might start interacting with an initially very simple environment of the AI world, i.e., an environment containing only one character and one environment element. Such a basic version of the AI world, in form of a plug-in to a Web browser (AI Player) may be obtained as a separate software package (with instructions of use) on a CD-ROM or downloaded over the Internet from the Ingeeni Studios, Inc. Website.

When a child becomes familiar with the initially simple rules of such a “bare” version, he or she will typically desire to change the character's behavior by inserting another character or event. Such insertion of a character or event, if repeated multiple times, will lead to building a more robust world, and will continuously drive the child to a desire to acquire more elements.

Such new desirable element can be obtained in different ways. In one preferred form of the invention, the key to obtaining a new character or element is the PowerCode, which needs to be typed in the computer by the child in order to activate the desirable element, so that the new element can be inserted into the AI world environment.

PowerCode is a unique piece of information that can be easily included with a number of products in the form of a printed coupon, thus enabling easy and widespread distribution. For example, a PowerCode can be supplied on a coupon inserted inside the packaging of food products, toy products or educational products. This helps promotion of both the AI Platform software and the particular products containing the PowerCode.

This way of distributing PowerCodes gives rise to a powerful business model. The desire for populating their virtual world causes children to explore ways in which they can obtain the PowerCode for the new elements or new characters.

Combining the distribution of PowerCode with distributing other goods, completely unrelated to the AI Platform, is a powerful marketing strategy. When presented with a choice between buying a product with or without PowerCode, the child's choice may be influenced by a desire to obtain another PowerCode and the child may choose the product which contains the PowerCode inside its packaging. In this way, marketers can help boost their sales by distributing a PowerCodes with their products. This way of distribution is particularly desirable with certain class of food products which target children, like breakfast cereals, chocolates, candies or other snacks, although it can also be implemented in the distribution of any product, i.e., children's movies, comic books, CDs, etc. Since PowerCode is easily stored on a number of media, e.g., paper media, electronic media, and/or Internet download, its distribution may also promote products distributed though less traditional channels, like Internet shopping, Web TV shopping, etc. It should also be appreciated that even though it may be more desirable to distribute PowerCodes with products whose target customers are children, it is also possible to distribute PowerCode with products designed for adults.

By way of example but not limitation, a PowerCode can be printed on a coupon placed inside a box of cereal. After the purchase of the cereal, the new desirable character or element can be downloaded from the Ingeeni Studios, Inc. Website, and activated with the PowerCode printed on a coupon.

The PowerCode obtained through buying a product will determine the particular environmental element or character delivered to the child. This element or character may be random. For example, a cereal box may contain a “surprise” PowerCode, where the element or character will only be revealed to the child after typing the PowerCode in the AI Platform application. Alternatively, a child might be offered a choice of some elements or characters. For example, a cereal box may contain a picture or name of the character or element, so that a child can deliberately choose an element that is desirable in the AI environment.

The child's AI Platform environment will grow with every PowerCode typed in; there is no limit as to how “rich” an environment can be created by a child using the characters and elements created and provided by Ingeeni Studios, Inc. or independent developers. Children will aspire to create more and more complex worlds, and they might compete with each other in creating those worlds so that the desire to obtain more and more characters will perpetuate.

Although the AI Platform is a game environment which may be designed primarily for entertainment purposes, in the process of playing the game, the children can also learn, i.e., as the child interacts with the AI world, he or she will learn to recognize correlations between the events and environmental elements of the AI world and the emotions and behavior of its characters. By changing the character's environment in a controlled and deliberate way, children will learn to influence the character's emotions and actions, thereby testing their acquired knowledge about the typical human emotions and behavior.

10.6 Learning System—User Interactions

The AI Platform can generate, without limitation, the following novel and beneficial interactions:

Method of Teaching—User as Teacher

The user can train an interactive animated character while learning him or herself. Creating a virtual character that fulfils the role of the student places the human user in the position of a teacher. The best way one learns any material is if one has to teach it. Thus, this technology platform gives rise to a powerful novel method of teaching through a teacher-student role reversal.

User as Coach

The user can train an interactive animated character while learning him or herself within a sports setting. The user trains the virtual athletes to increase characteristics such as their strength, balance, agility. The more athletes and sports accessories are collected, the more the user plays and trains the team. Additionally, once a whole team is collected (although the interaction can, without limitation, be created for a single-user sport, such as snowboarding or mountain biking a particular course), with an entire team, the user can play against a virtual team or against another user's team. In this way users can meet online, as in a chat room, and can compete, without limitation, their separately trained teams.

User as Caretaker (Pet Owner, Mom/Dad)

The User can have the interaction of a caretaker such as (but not limited to) a pet owner or a Mom or Dad. The User can take care of the animated interactive character, including (but not limited to), making certain that the character rests, eats, plays as necessary for proper growth.

In another aspect of the present invention, the platform's life-like animated characters can be harnessed for educational purposes.

More particularly, it has been recognized that one of the best ways to learn a skill is to teach that skill to someone else. This concept may be powerfully exploited in the context of the novel artificial intelligence platform, which provides life-like animated characters which can engage the user in a more interesting and powerful interactive experience. By providing the proper storyline and animated characters to a user, the user can be called upon to teach a skill to the animated characters and, in the process, learn that skill themselves. In essence, the process consists of (i) providing an interesting and interactive virtual world to the user; (ii) presenting a learning circumstance to the user through the use of this virtual world; (iii) prompting the user to provide instructions to the animated characters, wherein the instructions incorporate the skill to be taught to the user, such that the individual learns the skill by providing instructions to the animated characters; and (iv) providing a positive result to the user when the instructions provided by the individual are correct. For example, suppose a parent wishes to help teach a young child about personal grooming habits such as washing their hands, brushing their teeth, combing their hair, etc. Here, the young child might be presented with a virtual world in which an animated character, preferably in the form of a young child, is shown in its home. The child would be called upon to instruct the animated character on the grooming habits to be learned (e.g., brushing their teeth) and, upon providing the desired instructions, would receive some positive result (e.g., positive feedback, a reward, etc.).

What is claimed is:

1. A method for teaching a skill to an individual comprising:
providing a virtual world comprising:
a virtual environment;
a plurality of virtual elements within said virtual environment, each of said virtual elements being capable of interacting with other of said virtual elements within the virtual environment; and
user controls for enabling an individual to interact with at least one of said virtual elements within said virtual environment;
wherein at least one of said virtual elements comprises a virtual character comprising a behavior state, an emotion state and a learning state, and wherein said behavior state, said emotion state and said learning state are capable of changing in response to (i) interaction with other virtual elements within the virtual environment, and/or (ii) commands from said user controls;
presenting a learning circumstance to the individual through the use of said virtual elements within said virtual environment;
prompting the individual to provide instructions to at least one of the virtual elements within said virtual environment, wherein the instructions being provided by the individual incorporate the skill to be taught to the individual, such that the individual learns the skill by providing instructions to the at least one virtual element; and
providing positive reinforcement to the individual when the instructions provided by the individual are correct.

2. A method according to claim 1 wherein said instructions are provided to a virtual character.

3. A method according to claim 2 wherein the individual learns the skill by teaching that same skill to a virtual character.

4. A method according to claim 1 wherein said instructions comprise direct instructions.

5. A method according to claim 1 wherein said instructions comprise indirect instructions.

6. A method according to claim 5 wherein said indirect instructions comprise providing an example.

7. A method according to claim 5 wherein said indirect instructions comprise creating an inference.

8. A method according to claim 1 wherein said virtual environment is configured so that additional virtual elements can be introduced into said virtual environment.
